(19) United States
(12) Patent Application Publication
(10) Pub. No.: US 2025/0038954 A1
(43) Pub. Date: Jan. 30, 2025

(54) CRYPTOGRAPHIC CIPHER FOR HEALTHCARE COMPLIANT DATA TRANSACTIONS

(71) Applicant: David R. STEFANICH, Greenville, SC (US)

(72) Inventor: David R. STEFANICH, Greenville, SC (US)

(73) Assignee: RYMEDI, INC., Greenville, SC (US)

(21) Appl. No.: 18/662,760

(22) Filed: May 13, 2024

Related U.S. Application Data
(60) Provisional application No. 63/466,096, filed on May 12, 2023.
(60) Provisional application No. 63/584,261, filed on Sep. 21, 2023.
(60) Provisional application No. 63/584,275, filed on Sep. 21, 2023.
(60) Provisional application No. 63/584,286, filed on Sep. 21, 2023.

(51) Int. Cl. H04L 9/06; G06F 21/60; H04L 9/08; H04L 9/32

(52) U.S. Cl. CPC H04L 9/0631; G06F 21/602; H04L 9/0861; H04L 9/3236

(57) ABSTRACT

A method for applying a cryptographic cipher to healthcare compliant data transactions involves providing a data payload with transaction attributes, determining a subnet based on the attributes, and writing to a first subnet to obtain a transaction ID. A salt value is generated by hashing transaction IDs from multiple subnets and combining with a secret key from a cloud service to create an encryption key. The data payload is then encrypted using AES256 encryption and stored in a data table. This method ensures secure and compliant handling of sensitive healthcare data during transactions.

### CROSS-REFERENCE TO RELATED APPLICATION

This application claims the benefit of priority to U.S. Provisional Patent Application No. 63/466,096 filed May 12, 2023 and titled “METHODS AND SYSTEMS FOR MANAGING HEALTH DATA USING A BLOCKCHAIN-BASED DISTRIBUTED LEDGER”; U.S. Provisional Patent Application No. 63/584,261 filed Sep. 21, 2023 and titled “SYSTEMS AND METHODS OF DEPLOYING A CIPHER FOR COMPLIANCE TRANSACTIONS”; U.S. Provisional Patent Application No. 63/584,275 filed Sep. 21, 2023 and titled “CRYPTOGRAPHIC CIPHER FOR THE SEGMENTATION OF PERSONAL IDENTIFYING INFORMATION, PROTECTED HEALTH INFORMATION, AND PLATFORM PERMISSIONING”; and U.S. Provisional Patent Application No. 63/584,286 filed Sep. 21, 2023 and titled “CRYPTOGRAPHIC CIPHER FOR RETRIEVAL OF PERSONAL IDENTIFYING INFORMATION, PROTECTED HEALTH INFORMATION, AND PLATFORM.” The contents of the above applications are incorporated by reference in their entirety.

### FIELD

The present invention relates to cryptographic ciphers and, in particular, relates to cryptographic cipher for the segmentation, searching, and storing of personally identifiable information and/or protected health information.

### BACKGROUND

Cryptography is the practice of securing communication and information by converting it into an unreadable format (e.g., ciphertext). Cryptography provides confidentiality, integrity, and authenticity.

Ciphers are specific algorithms or methods used in cryptography to encrypt and decrypt data. For example, a cipher may transform plaintext (original data) into ciphertext (encrypted data) using a key. Ciphers come in various forms and complexities, and their choice depends on the specific security requirements of the application. Generally, there are two main types of cipher cryptography: symmetric ciphers and asymmetric ciphers.

In symmetric-key cryptography, the same key is used for both encryption and decryption. This means that the sender and receiver must share the same secret key. Examples of symmetric ciphers include the Advanced Encryption Standard (AES) and the Data Encryption Standard (DES). In asymmetric-key cryptography, a pair of keys are used: a public key for encryption and a private key for decryption (wherein information encrypted with the public key can only be decrypted with the corresponding private key). Examples of asymmetric ciphers include the Rivest-Shamir-Adleman (RSA) protocol and Elliptic Curve Cryptography (ECC).

Symmetric ciphers are generally faster and more efficient than asymmetric ciphers because they use a single key for both encryption and decryption. Symmetric ciphers are generally suitable for encrypting large volumes of data, for example. The primary challenge with symmetric ciphers is key management. Securely distributing and managing the secret keys among authorized parties can be complex, especially in large-scale systems.

Asymmetric ciphers generally simplify key management because you don't need to share secret keys. Public keys can be freely distributed, and private keys remain closely guarded by their respective owners. On the other hand, asymmetric ciphers are computationally more intensive than symmetric ciphers, which can make them slower for encrypting large amounts of data. Asymmetric ciphers, like RSA, play more of a role in access control (e.g., by establishing secure communication channels) and in verifying the authenticity of entities (e.g., during secure login processes or when transferring sensitive data over the internet).

In many industries and sectors, certain types of transactions are subject to regulatory oversight, laws, rules, guidelines, and/or standards to ensure transparency, safety, good corporate governance, etc. These compliance regimes are in place to protect consumers, prevent fraud, maintain market integrity, and/or achieve other public policy goals. When dealing with sensitive data subject to these compliance regimes, cryptographic ciphers play a critical role in ensuring data security and compliance.

Cryptographic ciphers, both symmetric and asymmetric, are used to encrypt sensitive data. For example, patient health records can be encrypted using strong symmetric ciphers like AES. AES is a widely adopted symmetric cipher known for its security and efficiency. It is commonly used to protect sensitive data, including patient records and clinical trial data. AES operates on fixed-size blocks of data and supports different key lengths (128, 192, or 256 bits); however, access to the decryption keys must be tightly controlled.

In another example, in healthcare and other industries under compliance regime(s), whether via AES or any other method/algorithm/protocol, data is often encrypted before being stored in databases or on servers. Decryption keys are securely managed, and access to the keys is controlled to ensure that only authorized personnel can decrypt and access the data. Asymmetric ciphers, like RSA, play a role in access control by establishing secure communication channels and verifying the authenticity of entities. For example, RSA is widely used in securing data transactions over the internet, including HTTPS, for secure web browsing and email encryption. RSA is also used for digital signatures, which can serve as a means of ensuring data authenticity and integrity. In compliance-driven scenarios, digital signatures may be required to validate the legitimacy of documents or transactions. In some cases, RSA keys can be used for access control and, when compliance mandates the creation of detailed audit trails, cryptographic techniques like RSA digital signatures can be employed to sign and verify audit logs (providing a secure and tamper-evident record of data access and transactions).

Cryptographic hashing, such as Secure Hash Algorithm 256-bit (SHA-256) is a secure hashing method used in these scenarios (e.g., to verify data integrity). Hashes of data are compared before and after transmission to ensure that data has not been altered during transit. In particular, SHA-256 is a cryptographic hash function that takes an input (message) and produces a fixed-size (256-bit) hash value. It is designed to be a one-way function, meaning it is computationally infeasible to reverse the process and obtain the original input from the hash value. For example, SHA-256 is commonly used for securely storing passwords. Instead of storing the actual password, a hash of the password is stored. When a user logs in, the system hashes the entered password and compares it to the stored hash. This way, even if the database is compromised, attackers will not immediately have access to user passwords.

Compliance regimes like the Health Insurance Portability and Accountability Act (HIPAA) in the U.S. and General Data Protection Regulation (GDPR) in the EU require healthcare organizations to implement robust data privacy and security measures. This includes encryption, access controls, and regular security assessments to protect patient data from breaches.

In the U.S., compliance varies based on the industry and the type of data being handled. For healthcare, HIPAA sets the standard for protecting patient data. Financial institutions follow regulations such as the Gramm-Leach-Bliley Act (GLBA) and the Sarbanes-Oxley Act (SOX). Government agencies adhere to the Federal Information Security Management Act (FISMA). Each of these regulations has its own requirements for data security, including the use of encryption, access controls, and audit trails. In the context of clinical trials, regulations such as those set by the U.S. Food and Drug Administration (FDA) mandate strict protocols for data collection, reporting, and storage. Data must be accurate, complete, and secure to meet compliance requirements. Failure to do so can result in legal consequences and delays in the approval process for new treatments. Compliance with regulatory bodies like the FDA also is essential for medical device manufacturers. The FDA reviews and approves devices based on safety and efficacy. Manufacturers must adhere to Quality System Regulation (QSR), for example, which outlines good manufacturing practices (GMPs) for medical devices. This includes the validation of manufacturing processes and data security measures to ensure product integrity.

Data privacy and security regulations are not limited to the U.S. For instance, GDPR in the European Union imposes strict requirements on how personal data is handled. Organizations conducting international business must navigate a complex landscape of national, regional, and global compliance regimes and adapt their practices accordingly. Various countries have their own regulations similar to HIPAA and GDPR to protect health data and ensure patient privacy. For example: The Personal Information Protection and Electronic Documents Act (PIPEDA) governs personal data, including health information in Canada; The Privacy Act 1988 regulates the handling of personal information, including health data in Australia; The Act on the Protection of Personal Information (APPI) governs the handling of personal information, including health records. There also exist international standards organizations like International Organization for Standardization (ISO) have developed standards such as ISO 13485, which provides a framework for a quality management system specific to medical devices. Many countries have adopted variations of these standards in their own regulatory frameworks.

Beyond healthcare, privacy laws such as the California Consumer Privacy Act (CCPA) and Brazil's General Data Protection Law (LGPD) have global implications for companies handling personal data.

With the above context in mind, compliance is a complex and evolving landscape, with both U.S.A. centric and global implications. Organizations that handle sensitive data, especially in healthcare and medical fields, must navigate a web of compliance regimes to ensure data privacy, security, and integrity, often requiring robust data protection measures and cryptographic techniques as discussed herein. There are, however, deficiencies with the current state of the art.

### SUMMARY

This summary is provided to introduce a selection of concepts or aspects in a simplified form that are further described below in the detailed description. This summary is not intended to identify key features or essential features of the claimed subject matter, nor is it intended to be used in isolation as an aid in determining the scope of the claimed subject matter.

In some aspects, the techniques described herein relate to a method for applying a cryptographic cipher for healthcare compliant data transactions, including: providing a data payload including attributes for a data transaction; determining a subnet associated with the attributes; writing to a first subnet; returning a transactionID from the first subnet; generating a salt value, including: requesting the transactionID of the first subnet, a second subnet, and a third subnet; and creating a salt value by performing a hash function on the transactionID of the first subnet, the second subnet, and the third subnet; creating an encryption key by combining a secret key from a cloud computing service and the salt value; performing a first encryption on the data payload using the encryption key, wherein the first encryption is an AES256 encryption; and passing the encrypted data payload to a data table.

In some aspects, the techniques described herein relate to a method for searching encrypted healthcare data objects, including: receiving a first data query including data to be searched for; generating a query hash from the first data query by: obtaining a transactionID relating to a first subnet, a second subnet, and a third subnet, stored a first database; and generating the query hash based on the transactionID for the first subnet, the second subnet, and the third subnet and a salt value obtained by performing a hash function on the transactionID of the first subnet, the second subnet, and the third subnet; generating a hash identifier by passing the query hash, including the transactionIDs and the salt value to hashing function, wherein the hashing function is a SHA256; parsing a second database for a match to the hash identifier; and returning contents of the second database that match the hash identifier.

In some aspects, the techniques described herein relate to a method for decrypting encrypted healthcare data objects, including: generating a salt value, including: requesting a transactionID of a first subnet, a second subnet, and a third subnet; and creating a salt value by performing a hash function on the transactionID of the first subnet, the second subnet, and the third subnet; creating an encryption key by combining a secret key from a cloud computing service and the salt value; performing a decryption on an encrypted data payload, and then performing an AES256 decryption on the encrypted data payload using the encryption key; and returning an unencrypted data payload.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. In the drawings:

FIG. 1 is an illustration of an example system and file structure currently available in the art to better explain the inventive concepts in the present disclosure;

FIG. 2 is an illustration of an example blockchain (node) architecture currently available in the art to better explain the inventive concepts in the present disclosure;

FIG. 3 is an illustration of example hardware that is useful for the inventive concepts according to the present disclosure;

FIGS. 4A and 4B, an illustration of an example blockchain (node) architecture used according to the present disclosure;

FIG. 5 is an illustration of an example encryption/cipher useful for a quad compliant application for a participant(s) using the system in Healthcare Testing, for example, according to the present disclosure;

FIG. 6 is an illustration of an example use of subnets according to the present disclosure regardless of the number of applications using the cryptographic cipher is shown;

FIG. 7 is an illustration of an example of one application according to the present disclosure;

FIG. 8A is an illustration of an example system and layers in the stack according to the present disclosure;

FIG. 8B is an illustration of an example application and the modules running on the application according to the present disclosure;

FIG. 9 is an illustration of an example of achievable inventive architecture according to the present disclosure;

FIG. 10 is an illustration of an example schematic flow diagram for a process of encrypting an unencrypted data payload according to the present disclosure;

FIG. 11 is an illustration of an example schematic flow diagram for a process of decrypting an encrypted data payload according to the present disclosure;

FIG. 12 is an illustration of an example schematic flow diagram for a process of storing encrypted data such that it can be searched without being decrypted according to the present disclosure;

FIG. 13 is an illustration of an example schematic flow diagram for a process of searching encrypted data without decrypting the encrypted data according to the present disclosure;

FIG. 14 is an illustration of an example schematic for a system architecture used to carry out the operations discussed herein, according to the present disclosure; and

FIG. 15A is a first half illustration of an example schematic for a system architecture used to carry out the operations discussed herein, according to the present disclosure;

FIG. 15B is a second half illustration of an example schematic for the system architecture of FIG. 15A, according to the present disclosure;

FIG. 16 is an illustration of a flowchart for a method of applying a cryptographic cipher according to the present disclosure;

FIG. 17 is an illustration of a flowchart for a method of storing data according to the present disclosure;

FIG. 18 is an illustration of a flowchart for a method of encrypting a data payload according to the present disclosure;

FIG. 19 is an illustration of a flowchart for a method of searching data according to the present disclosure;

FIG. 20 is an illustration of a flowchart for a method of retrieving data according to the present disclosure;

FIG. 21 is an illustration of a flowchart for a method of storing records according to the present disclosure;

FIG. 22 is an illustration of a flowchart for a method of creating an encryption key according to the present disclosure;

FIG. 23 is an illustration of a flowchart for a method of creating an encryption key according to the present disclosure;

FIG. 24 is an illustration of a flowchart for a method of encrypting a payload according to the present disclosure;

FIG. 25 is an illustration of a flowchart for a method of storing records according to the present disclosure;

FIG. 26 is an illustration of a flowchart for a method of storing records according to the present disclosure;

FIG. 27 is an illustration of a flowchart for a method of generating encryption keys;

FIG. 28 is an illustration of a flowchart for a method of retrieving records from a database according to the present disclosure;

FIG. 29 is an illustration of a flowchart for a method of applying a cryptographic cipher for healthcare compliant data transactions according to the present disclosure;

FIG. 30 is an illustration of a flowchart for a method of searching encrypted healthcare data objects according to the present disclosure; and

FIG. 31 is an illustration of a flowchart for a method of decrypting encrypted healthcare data objects according to the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises,” and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

Throughout this specification reference is made to “salt value,” “salt factor,” “generated salt,” “unique salt,” and “salt,” and they are used to reference differing embodiments of a salt that may be used with the encryption methods herein, as such the use of one shall be equivalent to the use of another when so appropriate.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### I. Example Use Case Scenario(s)

In one aspect, the present disclosure relates to cryptographic ciphers underlying the collection, storage, and retrieval of compliant data objects.

In another aspect, the present disclosure relates to a cryptographic cipher for the segmentation of personally identifiable information (PII), protected health information (PHI), and platform permissioning (PLAT).

In another aspect, the present disclosure relates to a cryptographic cipher for compliance transactions.

In another aspect, the present disclosure relates to a cryptographic cipher for storing and retrieving PII, PHI, and/or PLAT

In another aspect, the present disclosure relates to cryptographic algorithms for encrypting, decrypting, and/or reconstituting data, wherein the data is under one or more compliance regimes.

In another aspect, the systems and methods of the present disclosure leverage a combination of RSA signature, SHA-256, serialized blockchain protocol, and SALT encryption standards into a multi-regime compliant cipher.

In another aspect, the present disclosure relates to methods of processing data-transactions using cryptographic cipher(s) according to the present disclosure. The method, in one aspect, incorporates multithreading for increased cryptographic protection (e.g., monitoring, auditing, logging). The method, in another aspect, incorporates multithreading for efficient and effective database management (e.g., use of the storage space; use of processing resources; use of cache and translation lookaside buffer [TLB]). At all times, the method(s) of using the cryptographic algorithm(s) is in line with one or more compliance regimes.

In another aspect, the present disclosure generally relates to methods, systems, apparatuses, and non-transitory computer readable media employing a data storage and retrieval architecture utilizing key-based cryptography across distributed functions, to automate compliance with multiple regulatory regimes, for purposes of increased security, integrity, privacy, permissioned access, record keeping, and verification as compared to the conventional art.

In another aspect, the systems and methods of the present disclosure address and overcome one or more of the shortcomings and drawbacks of existing systems by building in heightened data access controls, traceability, and deidentification at the data architecture foundation, via public key cryptography, and via the separate storage of identity and digital transaction content, with compliance authentication hashed onto a permissionless distributed ledger, and by granting fine-tuned data access and use permissions on a need-to-know/need-to-use basis via allocation of cryptographic keys.

In another aspect, the systems and methods of the present disclosure provide for a data architecture that keeps PII and PHI separate via a PII private blockchain and PHI private blockchain that associates or ties PII, corresponding to a patient identifier, with a public key and with transaction identifier(s) (transactionID) generated from the private blockchains. In another aspect, for subsequent PII and/or PHI transactions, the PII private blockchain and the PHI private blockchain associate or tie PII with PHI, via the patient identifier (for example, a UUID) as well the relevant transactionID(s).

In another aspect, the systems and methods of the present disclosure relate to a system comprising a data compliance engine and a data repository, wherein the data architecture blends public and private blockchains to maximize speed, scalability, and security for participant interactions. In another aspect, the systems and methods of the present disclosure allows for simple user/participant experience and interface for entering encrypted payloads containing PII. In another aspect, the systems and methods of the present disclosure allow for automated clinical care processes for third-party consumers/exchangers/supervisors of system-managed data. In another aspect, the systems and methods of the present disclosure allow for digitalizing what is traditionally manual-entry administrative tasks on the side of the third-party consumers/exchangers/supervisors of system-managed data, or on the side of third-party participants transmitting PHI into the system. In another aspect, the systems and methods of the present disclosure allow for the system to integrate with third-part software to overly existing process, and/or to standardize data across partners and for data analysis tools. In another aspect, the systems and methods of the present disclosure provide immutable audit trails and data quality control mechanisms.

In another aspect, the systems and methods of the present disclosure allow for the creation and implementation of an FDA-Admissible Real-World Data Repository, which is a database or collection of health-related data derived from real-world sources such as electronic health records (EHRs), insurance claims, pharmacy records, patient registries, and wearable devices, that meet the standards and requirements set forth by the U.S. Food and Drug Administration (FDA) for use in regulatory decision-making processes. In another aspect, the systems and methods of the present disclosure include requirements related to data integrity, completeness, accuracy, privacy protection, and compliance with relevant regulations such as HIPAA (Health Insurance Portability and Accountability Act) for safeguarding patient information. In this way, in another aspect, the systems and methods of the present disclosure are configured for post-market surveillance, safety monitoring, comparative effectiveness research, and informing regulatory decision-making related to drug development and approval, medical device development and approval, etc. As such, in another aspect, the systems and methods of the present disclosure enable regulators or approved/permissioned third-party personnel (with proper credentialing, for example) to access real-world evidence to supplement traditional regulation-required data.

In another aspect, the system and methods of the present disclosure are implemented by leveraging a decentralized platform having multiple subnets providing fast, efficient, and scalable consensus mechanisms for distributed ledgers that record all transactions in a secure and immutable manner. The decentralized platform, in another aspect, is based on a metastable mechanism allowing for quick finality and high throughput. In another aspect, each block of the chain contains a cryptographic hash of the previous block, linking them together in a chain, as well as various other elements described herein.

In another aspect, each subnet of the decentralized network has its own rules, validators, and governance structures. Rules—or “operating procedures” governing transactions—refer to the set of guidelines or protocols that dictate how transactions are processed and validated within a specific subnet. These rules include parameters such as the consensus mechanism used, the block size, transaction fees, and any other conditions that determine how the subnet operates.

In another aspect, validators are responsible for verifying and validating transactions to ensure they meet the rules set forth by the subnet. Validators play a role in maintaining the integrity and security of the network by preventing fraudulent or invalid transactions from being included in the blockchain. Validators are typically nodes run by individuals or organizations that have staked collateral, which incentivizes them to act honestly and follow the rules of the subnet.

In another aspect, governance structures refer to the mechanisms and processes by which decisions are made and changes are implemented within the subnet. This includes protocols for electing validators, proposing and voting on changes to the subnet's rules, and resolving disputes or conflicts that may arise. Governance structures ensure that the subnet remains decentralized and autonomous.

In another aspect, the system and methods of the present disclosure are implemented by leveraging a sub-system that operates without a central authority or single point of control; instead, relying on a distributed network of nodes, wherein each node typically maintains a copy of the chain ledger. Moreover, the chain's software code and data on the nodes is freely available for anyone to view, search, and analyze. In this way, in another aspect, systems and methods of the present disclosure allow for third parties to view and search data or metadata associated with personally identifiable information (PII) and/or protected health information (PHI) (both of which are not stored on the distributed network/nodes and which cannot be obtained solely by use of the network/nodes), and allow for operators of the system to know what is being searched and what is being search for. As such, in another aspect, systems and methods of the present disclosure operate as a type of data broker that allows for sensitive information like PII and PHI to go into the system and out of the system, in an encryption and secure fashion, but that also allows for the exchange of PII and PHI (at a highly granular level) when permissioned, and which allows for removal of access to the shared PII and PHI when permissions are rescinded.

In another aspect, the systems and methods of the present disclosure are implemented by leveraging a proof-of-stake (POS) consensus mechanism or a proof-of-work (PoW) consensus mechanism used to achieve agreement on the state of the subnets/nodes among network participants. In a POS system, validators are selected to create and validate new blocks based on the amount of collateral they are willing to stake, or validators are chosen through various methods, such as random selection or based on their stake size. POS is known for its energy efficiency compared to PoW, where miners compete to solve complex mathematical puzzles.

In another aspect, the systems and methods of the present disclosure are implemented by leveraging the smart contract functionality of a decentralized platform comprising multiple subnets. In another aspect, the smart contracts are self-executing contracts with the terms of the agreement directly written into functions underlying the system. The functions/code execute and enforce the terms of the contract when predefined conditions are met. This functionality enables a wide range of use cases, including decentralized finance (DeFi), decentralized autonomous organizations (DAOs), and tokenization of assets.

In another aspect, the systems and methods of the present disclosure provides for issuance of a utility token providing access to a specific product or service using a subnet/node based ecosystem. In particular, the present disclosure relates to a utility token linked a system and network for encrypting, decrypting, searching, and storing PII and/or PHI, and allowing for the permissioned request/exchange of such data for clinical research studies, clinical trials, or the like. In another aspect, the systems and methods of the present disclosure leverage functions and protocols that enable the creation and management of access rights to PII and/or PHI, as are typically required by overarching governance/regulatory regimes. In another aspect, the systems and methods of the present disclosure leverage identity verification mechanisms to authenticate users requesting access to PII/PHI data. This may involve integrating with identity management solutions or leveraging chain/node-based encryption protocols and UUID-based permissioning for decentralized and verifiable identity verification. In another aspect, the systems and methods of the present disclosure maintain comprehensive audit trails and logging mechanisms to track node transactions, database access requests, and the storing of decrypted and encrypted payloads, all in an effort to ensure accountability, transparency, and compliance with regulatory requirements.

In another aspect, the systems and methods of the present disclosure leverage an Avalanche™ consensus algorithm to quickly confirm transactions, achieve high throughput, reduce splits, and allows for the creation of multiple subnets, which operate independently with their own rules, validators, and governance structures. In another aspect, the systems and methods of the present disclosure leverage Avalanche sub-protocols to confirm thousands of transactions per second (TPS). In another aspect, the systems and methods of the present disclosure leverage the Snow family of voting-based or quorum-based consensus protocols (e.g., Slush, Snowflake, Snowball, and/or Avalanche) to achieve randomized sampling and metastability to ascertain and persist transactions. In another aspect, the systems and methods of the present disclosure leverage

In another aspect, the systems and methods of the present disclosure leverage method-based functions defining behaviors or actions that objects of a class can perform, and that are associated with an object and can operate on the data within that object.

In another aspect, systems and methods of the present disclosure leverage a cryptographic cipher stack comprising a record management layer responsible for managing data records in a secure and organized manner, and providing functionalities for storing, retrieving, and managing records securely, ensuring data integrity, confidentiality, and availability. In another aspect, systems and methods of the present disclosure leverage a storeRecord function used to securely store a single record in the system, typically, by taking a data element as input and encrypting it using cryptographic techniques according to the present disclosure before storing it in a database or file system. In another aspect, systems and methods of the present disclosure leverage a storeMultipleRecords function similar to storeRecord but this function allows storing multiple records at once, usually provided as an array or collection of records. In another aspect, systems and methods of the present disclosure leverage a fetchRecord function that retrieves a single record from the storage system based on a specified identifier or criteria, and that decrypts the retrieved data before presenting it to the requester. In another aspect, systems and methods of the present disclosure leverage a fetchMultipleRecords function that, like the fetchRecord function, retrieves multiple records based on specified criteria or identifiers. In another aspect, systems and methods of the present disclosure leverage a fetchRecordIdentifier function that retrieves the identifier or key associated with a single record without revealing its contents. In another aspect, systems and methods of the present disclosure leverage a fetchMultipleRecordIdentifier function similar to the fetchRecordIdentifier function but for multiple records. In another aspect, systems and methods of the present disclosure leverage a fetchRecordMetaData function that retrieves metadata associated with a single record such as, for example, creation timestamp, owner, or any other relevant attributes. In another aspect, systems and methods of the present disclosure leverage a fetchMultipleRecordMetaData function similar to the fetchRecordMetaData but for multiple records.

In another aspect, systems and methods of the present disclosure leverage a hyper extended version of the Ethereum™ Virtual Machine (EVM) designed to offer additional features and capabilities beyond what is available in the traditional EVM. In another aspect, systems and methods of the present disclosure leverage hyper EVM functionalities that: execute transactions to store or retrieve records on a blockchain; implement access control mechanisms to ensure authorized access; and handle events emitted to update the state of records or trigger certain actions. In another aspect, systems and methods of the present disclosure leverage a hyperEVM for subnet protocol processing.

In another aspect, systems and methods of the present disclosure leverage external, separate storage databases or external services for system functions, in particular, for public functions related to the record manager. In another aspect, systems and methods of the present disclosure leverage a cloud vault connection constructor to handle environmental variables and/or to perform second key encryption or decryption, for example. In another aspect, systems and methods of the present disclosure leverage a cloud vault connection constructor to initialize object(s) responsible for securely storing and managing sensitive information such as cryptographic keys, passwords, and certificates, and to enable the record manager and/or hyper EVM to securely retrieve environment variables including encryption keys, API keys, or other sensitive information. In another aspect, systems and methods of the present disclosure leverage a cloud vault connection constructor to perform second key encryption and decryption operations where data encryption/decryption is done with a data encryption key and where the data encryption key itself is stored in the cloud vault. In another aspect, systems and methods of the present disclosure leverage a database constructor to initialize object(s) responsible for establishing a connection to the system database where encrypted records are stored, and for enabling the record manager and/or the hyper EVM to perform read and write operations. In another aspect, systems and methods of the present disclosure leverage dbconnection objects instantiated by the database constructor which provide methods for executing SQL queries, handing database transactions, and managing connections. In particular, in another aspect, systems and methods of the present disclosure leverage a database constructor to initialize an object responsible for connecting to Azure™ Key Vault, a service provided by Microsoft™ Azure™ for securely storing and managing sensitive information.

In another aspect, with more specificity, systems and methods of the present disclosure leverage a storerecord function that takes at least two parameters: payload and otherColumnData. The payload parameter represents the data to be stored, while otherColumnData includes any additional data to be stored alongside the payload. The function returns the rowID of the newly inserted record once the database transaction is complete. In another aspect, systems and methods of the present disclosure leverage a storerecord function with the following functionality. The function first encrypts the payload using second key encryption. This ensures that the payload is securely encrypted, adding an extra layer of protection. Next, the function generates a searchable hash for the payload; allowing for efficient searching and retrieval of records based on the payload content. The encrypted payload and the searchable hash are then stored in the database, along with any additional column data provided. This ensures that the encrypted data is securely stored and associated with relevant metadata. Finally, the function returns the rowID of the newly inserted record in the database, indicating that the database transaction was successful.

In another aspect, systems and methods of the present disclosure leverage a cryptographic cipher stack comprising a DB management (e.g., an RDBMSmanager for an RDBMS) layer responsible for managing read/write operations within the database instance, having a constructor that initializes a DBconnection object, and having public functions for storing records in the database, retrieving records based on rowID, fetching transactionIDs associated with a subnet, and retrieving hashing salt for a subnet, and private functions for internal use within the DBManager class, such as fetching names of all searchable columns in the database.

In another aspect, systems and methods of the present disclosure leverage a cryptographic cipher stack comprising a crypto management (e.g., a CryptoManager) layer responsible for managing the encryption and decryption process, having an EncryptedPassword constructor to incorporate password-related encryption, and having public functions such as generateHash, encryptData, and decryptData (which are accessible by other components such as the record manager and hyper EVM to perform cryptographic operations on sensitive data), and private functions for generating a cryptographic salt from a given source, obtaining three references from parameters and a fourth reference from a third party separate cloud vault, obtaining or generating a primary encryption key, performing secondary or tertiary encryption or hashing, and decrypting data encrypted using the second encryption key, etc.

In another aspect, with more specificity, systems and methods of the present disclosure leverage a createEncryptionKey function that takes at least three parameters: an identifier for a PII subnet transaction; an identifier for a PHI subnet transaction; and an identifier for a platform subnet transaction. The function returns the encryption key, ready to be utilized for cryptographic operations. In another aspect, systems and methods of the present disclosure leverage a createEncryptionKey function with the following functionality. The function begins by retrieving all the necessary references required for key generation including the transactionIDs provided as parameters, serving as inputs to the key derivation process. Next, the function generates a cryptographic salt using the retrieved references. Next, the function utilizes the PII subnet transactionID, the PHI subnet transactionID, and the platform subnet transactionID to generate a salt, and then the function proceeds to generate the encryption key via the generated salt and a password stored on a cloudvault, for example.

In another aspect, with more specificity, systems and methods of the present disclosure leverage a createEncryptionKey function with the following functionality. The function starts by extracting all three transactionIDs from a cipher table. Next, the function accesses the Azure Vault to retrieve the fourth reference, which serves as the password. The function next calls a SHA-256 hashing function to generate a cryptographic salt. Next, the function accesses the generateSalt function and the password (the fourth reference) obtained from the Azure Vault. Finally, the function utilizes the obtained references (transactionIDs and password) to invoke a PBKDF2 (Password-Based Key Derivation Function 2) function to iteratively apply a cryptographic hash function to derive the encryption key.

In another aspect, with more specificity, systems and methods of the present disclosure leverage an EncryptData function with the following functionality. The EncryptData function starts by calling the createEncryptionKey function, passing the first, second, and third subnet transactionIDs as parameters. This step generates a secure encryption key. Once the encryption key is generated, the function invokes the performFirstKeyEncryption function from the CryptoManager layer which passes the encryption key along with the unencrypted payload. With the payload encrypted using the primary key, the function proceeds to perform a second layer of encryption for enhanced security. It calls the performSecondEncryption function, passing the encrypted payload.

In another aspect, with more specificity, systems and methods of the present disclosure leverage a StoreRecord function with the following functionality. The function begins by retrieving the necessary transactionIDs, including the first, second, and third subnet transactionIDs, from the database via the getSubnetTxIds function. Next, the function calls the encryptData function, passing the unencrypted payload along with the reference transactionIDs obtained in the previous step. This results in the generation of an encrypted payload. The function extracts the relevant value from the otherColumnData, which contains additional information to be stored alongside the payload. Using the obtained transactionIDs, the function calls the getHashingSaltForSubnet function to retrieve the corresponding salts from the database. The function passes the extracted value and salts to the generateHash function, which calculates the hash of the value using a secure hashing algorithm. This hash serves as a searchable identifier for the stored data. The function next invokes the storeRecordInDB function, passing the encrypted payload along with relevant query parameters to store the encrypted data securely in the database. Similarly, the function calls the storeRecordInDB function again, this time passing the generated hash along with query parameters to store the searchable hash associated with the stored data. Upon successful completion of the database transaction, the function returns the rowID, which serves as the unique identifier for the stored record in the database.

In another aspect, with more specificity, systems and methods of the present disclosure leverage a fetchRecord function with the following functionality. The function starts by retrieving the necessary salts from the database by calling the getHashingSaltForSubnet function. Using the obtained salts, the function calls the generateHash function, passing the searchableString and salts. This generates a hash of the searchable string. The function next calls the getRecordInDB function, passing the generated hash and the optional columnNameToSearch. This function queries the database to find the matching record based on the generated hash and the specified column name, if provided. If a matching record is found in the database, the function calls the getRecordInDB function again to retrieve the encrypted payload associated with the record. Once the encrypted payload is obtained, the function calls the getSubnetTxId function to retrieve the necessary transactionIDs (e.g., first, second, and third subnet transactionIDs) from the database. Using the retrieved transactionIDs, the function calls the decryptData function, passing the encrypted payload and transactionIDs as parameters. This function decrypts the encrypted payload to obtain the original, unencrypted payload. Finally, the function returns the decrypted payload, providing access to the desired data associated with the searchable string.

In another aspect, with more specificity, systems and methods of the present disclosure leverage a fetchRecordIdentifier function with the following functionality. The function initiates by retrieving the necessary salts from the database using the getHashingSaltForSubnet function. Using the obtained salts, the function calls the generate Hash function, passing the searchableString and salts. This generates a hash of the searchable string. The function iterates through every row in the database, attempting to match the generated hash with the stored hashes. This step ensures thorough coverage of all records in the database. If a matching record is found within the database, the function calls the getRecordInDB function to retrieve the corresponding row ID associated with the matched record. Finally, the function returns the retrieved row ID, providing access to the unique identifier associated with the matching record.

In another aspect, with more specificity, systems and methods of the present disclosure leverage a fetchRecordMetadata function with the following functionality. The function initiates by retrieving the necessary salts from the database using the get HashingSaltForSubnet function. Using the obtained salts, the function calls the generateHash function, passing the searchableString and salts as parameters. The function iterates through every row in the database, attempting to match the generated hash with the stored hashes. This step ensures thorough coverage of all records in the database. If a matching record is found within the database, the function calls the getRecordInDB function to retrieve the corresponding metadata associated with the matched record. Finally, the function returns the retrieved metadata, providing access to additional information associated with the matching record.

In another aspect, with more specificity, systems and methods of the present disclosure leverage a storeRecordinDB function with the following functionality. The function starts by determining the appropriate database table to store the payload based on the provided DBTableParam. This ensures that the payload is stored in the correct location within the database schema. Once the database table is identified, the function proceeds to store the payload securely in the database, for example, by executing an SQL query to insert the payload into the specified table, adhering to any defined constraints or validations. After successfully storing the payload in the database, the function generates a unique transactionID to serve as an identifier for the stored record. This transactionID is distinct from the transactionIDs used within the subnets and provides a reference to the stored data within the RDBMS. The function returns the generated transactionID, allowing external components to reference and retrieve the stored record in the database as needed.

In another aspect, with more specificity, systems and methods of the present disclosure leverage a getRecordinDB function with the following functionality. The function initiates by querying the RDBMS based on the provided hash value. This query searches for a record matching the specified hash in the database table. Upon executing the database query, the function retrieves the record matching the provided hash from the database. This record typically consists of multiple columns containing various attributes or metadata associated with the stored data. Optional, if column specifications are provided, the function filters the retrieved record based on the specified columns. Finally, the function returns the retrieved record, providing access to the relevant information stored in the database associated with the provided hash.

In another aspect, with more specificity, systems and methods of the present disclosure leverage a getSubnetTXids function with the following functionality. The function starts by querying the RDBMS based on a provided identifier. This query retrieves a PII trxID, PHI trxID, and a PLATFORM trxID obtained from data transactions to the first, second, and third subnets.

In another aspect, with more specificity, systems and methods of the present disclosure leverage a getHashingSaltforSubnet function with the following functionality. The function initiates by querying the RDBMS to retrieve the hashing salt associated with the specified subnet transactionIDs. This query is based on the provided transactionIDs to ensure the retrieval of the correct salt. Upon executing the database query, the function retrieves the hashing salt associated with the specified subnet transactionIDs.

In another aspect, with more specificity, systems and methods of the present disclosure leverage a generateSaltfromSource function with the following functionality. The function begins by combining the provided sources to create a unified input for salt generation. These sources could include various factors as described in detail herein. Once the sources are combined, the function hashes the unified input using a secure hashing algorithm such as SHA-256. After hashing the combined sources, the function derives the hashing salt from the resulting hash value.

In another aspect, with more specificity, systems and methods of the present disclosure leverage a generateSaltfromSource function with the following functionality. The function starts by combining the provided data with the salt. Once the data and salt are combined, the function computes the hash value using a secure hashing algorithm such as SHA-256. This algorithm transforms the combined input into a fixed-length hash value.

In another aspect, systems and methods of the present disclosure are configured for securely storing data, the method comprising: retrieving transactionIDs associated with subnets from a database; encrypting payload data using the retrieved transactionIDs as references; generating a hash value of additional data and storing it securely; storing the encrypted payload and hash value in a database; and returning a row ID associated with the stored record and a transactionID.

In another aspect, systems and methods of the present disclosure are configured for generating encryption keys, the method comprising: retrieving references including subnet transactionIDs and a password from a secure storage; combining the retrieved references to generate a unique salt; utilizing a key derivation function with the combined salt and password to generate an encryption key; and providing the encryption key for subsequent encryption operations.

In another aspect, systems and methods of the present disclosure are configured for retrieving records from a database, the method comprising: retrieving hashing salts associated with subnet transactionIDs from a database; generating a hash value of a searchable string using the retrieved hashing salts; searching for a matching record in the database based on the generated hash value; retrieving the desired record from the database based on the search results; decrypting the retrieved record, if encrypted, using appropriate encryption keys; and returning the decrypted record to the requester.

In another aspect, systems and methods of the present disclosure have the following data flow sequence: a user completes the form on the front end; the new user data will be passed to the irbService/saveUserInput( ) API endpoint; all the user data that are relevant for irbcontent table and the blockchain will be passed to the javascript library; JS application will pass the separated out data fields (hashable, encryptable and un-encryptable) to the storeRecord( ) as parameter; inside storeRecord (data, subnet_reference), initialize the SubnetManager by providing the connection details such as providerURL, privateKeys, and contractAddress; create the hashes of the required fields in data; insert the un-encryptable data and the hashes of the field to the irbcontent table; push selected fields from the data to the PII subnet by calling pushRecord( ) from the SubnetManager and get the transactionID; perform the encryption, call the encryptData( ) from the cryptoManager to encrypt the payload; inside encryptData( ) create the encryption key via createEncryptionKey( ) which will generate the password from the given key (transactionID), secret from the Azure Vault and the random salt; performFirstKeyEncryption( ) which will perform the AES256 encryption on the given payload with the help of the created key; performSecondKeyEncryption( ) which will perform the Azure's vault encryption on the already encrypted payload; save the encryption descriptor in the cypher_descriptor table and get the reference id of the row; save the encrypted payload, transactionID, encryption descriptor and the random salt in the irbcontent table; column name will be encrypted_payload, transaction_id, fk_encryption_descriptor_id and encryption_salt respectively; return the row of irbcontent if the process is complete.

### II. Systems and Methods

Aspects of the present disclosure are directed to architecture and software mechanisms utilizing three distributed, encrypted database networks to separately store identity and digital transaction content and compliance authentication data, together with three types of cryptographic keys corresponding to each network that are combined via governing algorithms, to produce digital subnet information from each identity and digital transaction content permissioned for that transaction, via cryptographic keys.

In another aspect, the identity and digital transaction content networks are distributed across: (1) permissionless distributed ledger technologies, (2) permissioned distributed ledgers, (3) various kinds of cloud and on-premises database server networks, or (4) edge compute storage on specific devices or edge networks.

In another aspect, the systems and methods according to the present disclosure are implemented on a processor-based computing device or computer. A computer may comprise at least one processor that is connected to a network interface, and a memory. In general, the processor may interact and control these components, as well as other components of the computer, to orchestrate the functioning of the device. The network interface may comprise circuitry configured to communicate with other devices over various networks, such as the internet. As an example, the network interface may comprise modems, wireless radios (e.g., cellular transceivers), or other devices that are designed to communicate with network access points, such as cellular towers, network routers, Wi-Fi hots spots, or other types of access points. The network interface may be used to communicate with other computers and, in some aspects other types of electronic devices. The computer may include other types of interfaces, such as a short-range communication interface. The memory is connected to and editable by the processor. The memory may store, among other things, one or more cryptographic private keys, control logic used to orchestrate the functioning of the computer including logic implementing the functions described above, and various databases of information, including identity data encrypted with a first cryptographic key, digital transaction content with a second cryptographic key and compliance authentication data encrypted with a third cryptographic key. In operation, the processor may execute the instructions of its control logic to manage data transactions. This may involve communicating with other computers to obtain (or produce) authorizing signatures as well as communicating with (nodes of) the ledger network. The control logic can be implemented in software, hardware, firmware or any combination thereof and/or stored in memory. When implemented in software, the control logic can be stored and transported on any computer-readable medium for use by or in connection with an instruction execution apparatus that can fetch and execute instructions, such as the processor. Relatedly, the control logic may be part of a software application running on the computer. For example, the control logic may be part of a software application (“app”) of a client or third-party.

In another aspect, the systems and methods according to the present disclosure include: at least one non-transitory storage device; and at least one processing device coupled to the at least one non-transitory storage device, wherein the at least one processing device is configured to: receive a first data packet associated with a first user, wherein the first data packet is assigned a unique user identifier based on the first user; cause an encryption of the first data packet using a plurality of encryption keys, wherein at least one of the plurality of encryption keys is based on the unique user identifier; store at least one of the plurality of encryption keys for the encrypted first data packet on a first distributed ledger subnet, wherein the first distributed ledger subnet is determined based on a data type of the first data packet; receive the at least one of the plurality of encryption keys for the encrypted first data packet stored on the first distributed ledger subnet; and cause a decryption of the first data packet based on the at least one of the plurality of encryption keys for the encrypted first data packet stored on the first distributed ledger subnet.

In another aspect, the systems and methods according to the present disclosure relate to a system, wherein the first distributed ledger subnet is one of a PII subnet, a PHI subnet, or a platform subnet.

In another aspect, the systems and methods according to the present disclosure relate to a system, further including a plurality of distributed ledger subnets, wherein the first distributed ledger subnet is determined from the plurality of distributed ledger subnets.

In another aspect, the systems and methods according to the present disclosure relate to a system, wherein each of the plurality of distributed ledger subnets contains information relating to a different data type.

In another aspect, the systems and methods according to the present disclosure relate to system, wherein the at least one processing device is further configured to determine the data type for the first data packet based on the first data packet.

In another aspect, the systems and methods according to the present disclosure relate to a system, wherein the at least one processing device is further configured to determine the first distributed ledger subnet based on the data type of the first data packet.

In another aspect, the systems and methods according to the present disclosure relate to a system, wherein the at least one processing device is further configured to generate the unique user identifier based on the first user.

In another aspect, the systems and methods according to the present disclosure relate to a system, wherein the at least one processing device is further configured to store the encrypted first data packet in a data management database.

In another aspect, the systems and methods according to the present disclosure relate to a system, wherein the at least one processing device is further configured to: receive a second data packet associated with the first user; cause an encryption of the second data packet using the plurality of encryption keys, wherein at least one of the plurality of encryption keys is based on the unique user identifier; and store at least one of the plurality of encryption keys for the encrypted second data packet on a second distributed ledger subnet, wherein the second distributed ledger subnet is determined based on a data type of the second data packet.

In another aspect, the systems and methods according to the present disclosure relate to a system, wherein the at least one processing device is further configured to: receive the at least one of the plurality of encryption keys for the encrypted second data packet stored on the second distributed ledger subnet; and cause a decryption of the second data packet based on the at least one of the plurality of encryption keys for the encrypted second data packet stored on the second distributed ledger subnet.

In another aspect, the systems and methods according to the present disclosure relate to a system, wherein the at least one processing device is further configured to: receive a second data packet associated with a second user, wherein the second data packet is assigned a unique user identifier based on the second user; cause an encryption of the second data packet using a plurality of encryption keys, wherein at least one of the plurality of encryption keys is based on the unique user identifier based on the second user; and store at least one of the plurality of encryption keys for the encrypted second data packet on the first distributed ledger subnet, wherein the first distributed ledger subnet is determined based on a data type of the second data packet, wherein the second data packet shares the data type with the first data packet.

In another aspect, the systems and methods according to the present disclosure relate to a system, wherein the at least one processing device is further configured to: receive the at least one of the plurality of encryption keys for the encrypted second data packet stored on the first distributed ledger subnet; and cause a decryption of the second data packet based on the at least one of the plurality of encryption keys for the encrypted second data packet stored on the first distributed ledger subnet.

In another aspect, the systems and methods according to the present disclosure relate to a system, wherein the at least one processing device is further configured to generate each of a plurality of distributed ledger subnets, wherein each of the plurality of distributed ledger subnet are dedicated to a specific data type.

In another aspect, the systems and methods according to the present disclosure relate to a system, wherein the at least one processing device is further configured to cause a transmission of the decrypted first data packet to a computing device associated with an entity.

In another aspect, the systems and methods according to the present disclosure relate to a system, wherein the at least one processing device is further configured to receive a request for the first data packet associated with the first user.

In another aspect, the systems and methods according to the present disclosure relate to a system, wherein the request for the first data packet associated with the first user is approved by the first user.

In another aspect, the systems and methods according to the present disclosure relate to a system, wherein the at least one of the plurality of encryption keys for the encrypted first data packet stored on the first distributed ledger subnet is stored as a block on the first distributed ledger subnet.

In another aspect, the systems and methods according to the present disclosure relate to a system, wherein the at least one of the plurality of encryption keys for the encrypted first data packet stored on the first distributed ledger subnet is the unique user identifier based on the first user.

In another aspect, the systems and methods according to the present disclosure relate to a system, wherein the unique user identifier based on the first user is combined with each of the plurality of encryption keys to generate a decryption key.

In another aspect, the systems and methods according to the present disclosure relate to a system, wherein a transaction Identifier is generated for the first data packet, wherein the transaction Identifier is stored on the first distributed ledger subnet.

In another aspect, the systems and methods according to the present disclosure relate to a method for managing health data, including: receiving a first data packet associated with a first user, wherein the first data packet is assigned a unique user identifier based on the first user; causing an encryption of the first data packet using a plurality of encryption keys, wherein at least one of the plurality of encryption keys is based on the unique user identifier; storing at least one of the plurality of encryption keys for the encrypted first data packet on a first distributed ledger subnet, wherein the first distributed ledger subnet is determined based on a data type of the first data packet; receiving the at least one of the plurality of encryption keys for the encrypted first data packet stored on the first distributed ledger subnet; and causing a decryption of the first data packet based on the at least one of the plurality of encryption keys for the encrypted first data packet stored on the first distributed ledger subnet.

In another aspect, the systems and methods according to the present disclosure relate to a method, wherein the first distributed ledger subnet is one of a PII subnet, a PHI subnet, or a platform subnet.

In another aspect, the systems and methods according to the present disclosure relate to a method, wherein the first distributed ledger subnet is determined from a plurality of distributed ledger subnets.

In another aspect, the systems and methods according to the present disclosure relate to a method, wherein each of the plurality of distributed ledger subnets contains information relating to a different data type.

In another aspect, the systems and methods according to the present disclosure relate to a method, further including determining the data type for the first data packet based on the first data packet.

In another aspect, the systems and methods according to the present disclosure relate to a method, further including determining the first distributed ledger subnet based on the data type of the first data packet.

In another aspect, the systems and methods according to the present disclosure relate to a method, further including generating the unique user identifier based on the first user.

In another aspect, the systems and methods according to the present disclosure relate to a method, further including storing the encrypted first data packet in a data management database.

In another aspect, the systems and methods according to the present disclosure relate to a method, further including: receiving a second data packet associated with the first user; causing an encryption of the second data packet using the plurality of encryption keys, wherein at least one of the plurality of encryption keys is based on the unique user identifier; and storing at least one of the plurality of encryption keys for the encrypted second data packet on a second distributed ledger subnet, wherein the second distributed ledger subnet is determined based on a data type of the second data packet.

In another aspect, the systems and methods according to the present disclosure relate to a method, further including: receiving the at least one of the plurality of encryption keys for the encrypted second data packet stored on the second distributed ledger subnet; and causing a decryption of the second data packet based on the at least one of the plurality of encryption keys for the encrypted second data packet stored on the second distributed ledger subnet.

In another aspect, the systems and methods according to the present disclosure relate to a method, further including: receiving a second data packet associated with a second user, wherein the second data packet is assigned a unique user identifier based on the second user; causing an encryption of the second data packet using a plurality of encryption keys, wherein at least one of the plurality of encryption keys is based on the unique user identifier based on the second user; and storing at least one of the plurality of encryption keys for the encrypted second data packet on the first distributed ledger subnet, wherein the first distributed ledger subnet is determined based on a data type of the second data packet, wherein the second data packet shares the data type with the first data packet.

In another aspect, the systems and methods according to the present disclosure relate to a method, further including: receiving the at least one of the plurality of encryption keys for the encrypted second data packet stored on the first distributed ledger subnet; and causing a decryption of the second data packet based on the at least one of the plurality of encryption keys for the encrypted second data packet stored on the first distributed ledger subnet.

In another aspect, the systems and methods according to the present disclosure relate to a method, wherein the at least one processing device is further configured to generate each of a plurality of distributed ledger subnets, wherein each of the plurality of distributed ledger subnet are dedicated to a specific data type.

In another aspect, the systems and methods according to the present disclosure relate to a method, further including causing a transmission of the decrypted first data packet to a computing device associated with an entity.

In another aspect, the systems and methods according to the present disclosure relate to a method, further including receiving a request for the first data packet associated with the first user.

In another aspect, the systems and methods according to the present disclosure relate to a method, wherein the request for the first data packet associated with the first user is approved by the first user.

In another aspect, the systems and methods according to the present disclosure relate to a method, wherein the at least one of the plurality of encryption keys for the encrypted first data packet stored on the first distributed ledger subnet is stored as a block on the first distributed ledger subnet.

In another aspect, the systems and methods according to the present disclosure relate to a method, wherein the at least one of the plurality of encryption keys for the encrypted first data packet stored on the first distributed ledger subnet is the unique user identifier based on the first user.

In another aspect, the systems and methods according to the present disclosure relate to a method, wherein the unique user identifier based on the first user is combined with each of the plurality of encryption keys to generate a decryption key.

In another aspect, the systems and methods according to the present disclosure relate to a method, wherein a transaction identifier is generated for the first data packet, wherein the transaction identifier is stored on the first distributed ledger subnet.

In another aspect, the systems and methods according to the present disclosure relate to a computer program product for reformatting data, the computer program product including at least one non-transitory computer-readable medium having one or more computer-readable program code portions embodied therein, the one or more computer-readable program code portions including at least one executable portion configured to: receive a first data packet associated with a first user, wherein the first data packet is assigned a unique user identifier based on the first user; cause an encryption of the first data packet using a plurality of encryption keys, wherein at least one of the plurality of encryption keys is based on the unique user identifier; store at least one of the plurality of encryption keys for the encrypted first data packet on a first distributed ledger subnet, wherein the first distributed ledger subnet is determined based on a data type of the first data packet; receive the at least one of the plurality of encryption keys for the encrypted first data packet stored on the first distributed ledger subnet; and cause a decryption of the first data packet based on the at least one of the plurality of encryption keys for the encrypted first data packet stored on the first distributed ledger subnet.

In another aspect, the systems and methods according to the present disclosure relate to a computer program product, wherein the first distributed ledger subnet is one of a PII subnet, a PHI subnet, or a platform subnet.

In another aspect, the systems and methods according to the present disclosure relate to a computer program product, wherein the first distributed ledger subnet is determined from the plurality of distributed ledger subnets.

In another aspect, the systems and methods according to the present disclosure relate to a computer program product, wherein each of the plurality of distributed ledger subnets contains information relating to a different data type.

In another aspect, the systems and methods according to the present disclosure relate to a computer program product, wherein the one or more computer-readable program code portions include at least one executable portion further configured to determine the data type for the first data packet based on the first data packet.

In another aspect, the systems and methods according to the present disclosure relate to a computer program product, wherein the one or more computer-readable program code portions include at least one executable portion further configured to determine the first distributed ledger subnet based on the data type of the first data packet.

In another aspect, the systems and methods according to the present disclosure relate to a computer program product, wherein the one or more computer-readable program code portions include at least one executable portion further configured to generate the unique user identifier based on the first user.

In another aspect, the systems and methods according to the present disclosure relate to a computer program product, wherein the one or more computer-readable program code portions include at least one executable portion further configured to store the encrypted first data packet in a data management database.

In another aspect, the systems and methods according to the present disclosure relate to a computer program product, wherein the one or more computer-readable program code portions include at least one executable portion further configured to: receive a second data packet associated with the first user; cause an encryption of the second data packet using the plurality of encryption keys, wherein at least one of the plurality of encryption keys is based on the unique user identifier; and store at least one of the plurality of encryption keys for the encrypted second data packet on a second distributed ledger subnet, wherein the second distributed ledger subnet is determined based on a data type of the second data packet.

In another aspect, the systems and methods according to the present disclosure relate to a computer program product, wherein the one or more computer-readable program code portions include at least one executable portion further configured to: receive the at least one of the plurality of encryption keys for the encrypted second data packet stored on the second distributed ledger subnet; and cause a decryption of the second data packet based on the at least one of the plurality of encryption keys for the encrypted second data packet stored on the second distributed ledger subnet.

In another aspect, the systems and methods according to the present disclosure relate to a computer program product, wherein the one or more computer-readable program code portions include at least one executable portion further configured to: receive a second data packet associated with a second user, wherein the second data packet is assigned a unique user identifier based on the second user; cause an encryption of the second data packet using a plurality of encryption keys, wherein at least one of the plurality of encryption keys is based on the unique user identifier based on the second user; and store at least one of the plurality of encryption keys for the encrypted second data packet on the first distributed ledger subnet, wherein the first distributed ledger subnet is determined based on a data type of the second data packet, wherein the second data packet shares the data type with the first data packet.

In another aspect, the systems and methods according to the present disclosure relate to a computer program product, wherein the one or more computer-readable program code portions include at least one executable portion further configured to: receive the at least one of the plurality of encryption keys for the encrypted second data packet stored on the first distributed ledger subnet; and cause a decryption of the second data packet based on the at least one of the plurality of encryption keys for the encrypted second data packet stored on the first distributed ledger subnet.

In another aspect, the systems and methods according to the present disclosure relate to a computer program product, wherein the one or more computer-readable program code portions include at least one executable portion further configured to generate each of a plurality of distributed ledger subnets, wherein each of the plurality of distributed ledger subnet are dedicated to a specific data type.

In another aspect, the systems and methods according to the present disclosure relate to a computer program product, wherein the one or more computer-readable program code portions include at least one executable portion further configured to cause a transmission of the decrypted first data packet to a computing device associated with an entity.

In another aspect, the systems and methods according to the present disclosure relate to a computer program product, wherein the one or more computer-readable program code portions include at least one executable portion further configured to receive a request for the first data packet associated with the first user.

In another aspect, the systems and methods according to the present disclosure relate to a computer program product, wherein the request for the first data packet associated with the first user is approved by the first user.

In another aspect, the systems and methods according to the present disclosure relate to a computer program product, wherein the at least one of the plurality of encryption keys for the encrypted first data packet stored on the first distributed ledger subnet is stored as a block on the first distributed ledger subnet.

In another aspect, the systems and methods according to the present disclosure relate to a computer program product, wherein the at least one of the plurality of encryption keys for the encrypted first data packet stored on the first distributed ledger subnet is the unique user identifier based on the first user.

In another aspect, the systems and methods according to the present disclosure relate to a computer program product, wherein the unique user identifier based on the first user is combined with each of the plurality of encryption keys to generate a decryption key.

In another aspect, the systems and methods according to the present disclosure relate to a computer program product, wherein a transaction identifier is generated for the first data packet, wherein the transaction identifier is stored on the first distributed ledger subnet.

In some embodiments, the architecture and software mechanism utilizes three distributed, encrypted database networks to separately store identity, digital transaction content and compliance authentication data, together with three types of cryptographic keys corresponding to each network that are combined via governing algorithms to produce digital transactions with only the subset of information from each identity and digital transaction content network permissioned for that transaction via two cryptographic keys linked to each network and compliance authentication provided via the third key linked to the compliance authentication network.

In other embodiments, the identity and digital transaction content networks are distributed across permissionless distributed ledger technologies, permissioned distributed ledgers, various kinds of cloud and on-premises database server networks, and edge compute storage on specific devices or edge networks.

### III. With Reference to the Figures

Reference will now be made in detail to aspects of the invention(s), examples of which are illustrated in the accompanying drawings. The following description refers to the accompanying drawings in which the same numbers in different drawings represent the same or similar elements unless otherwise represented. The implementations set forth in the following description do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Systems, methods, and apparatuses are described herein which relate generally to a software mechanism and data storage and retrieval architecture utilizing public key cryptography across distributed functions to automate health data compliance with regulatory and standards criteria for security, integrity, privacy, permissioned access, record keeping, and verifiability of these criteria for use of that data in software, firmware, and hardware. In the following description, for purposes of explanation, numerous specific details are set forth to provide a thorough understanding of the present invention. It will be evident, however, to one skilled in the art that the present invention may be practiced without these specific details and/or with any combination of these details.

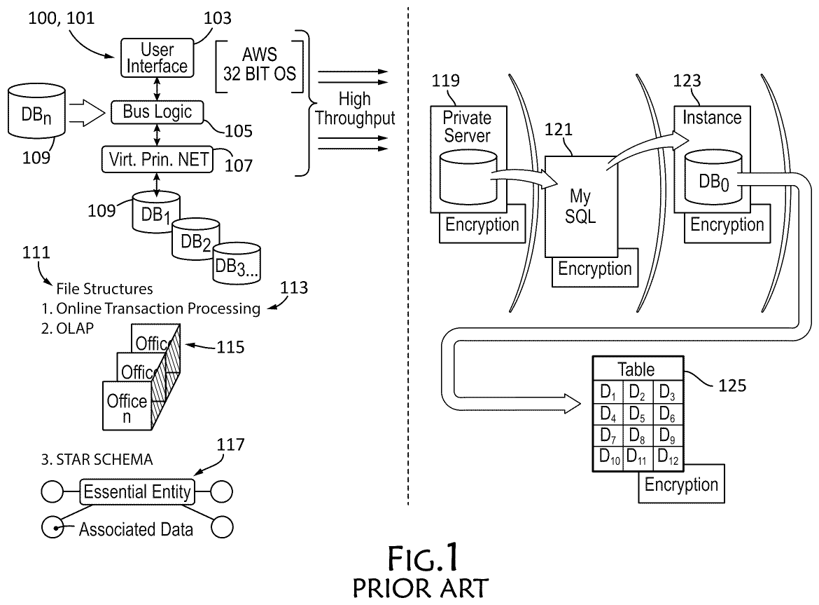

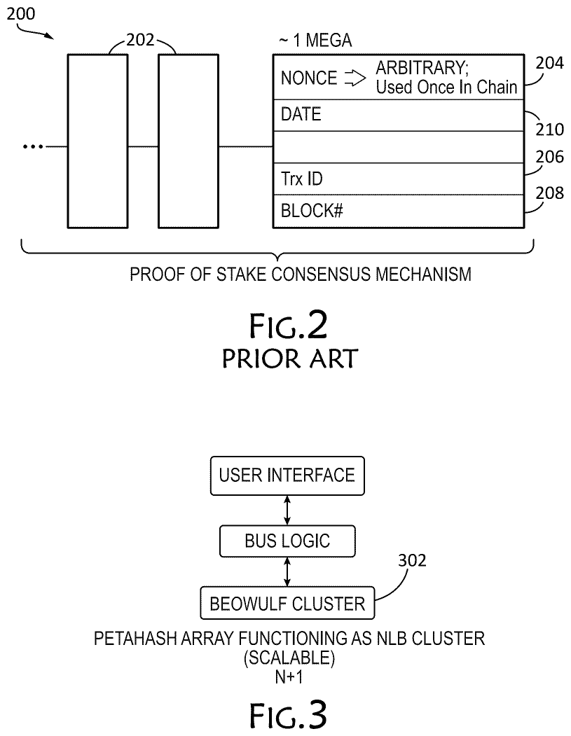

Turning now to the figures, FIG. 1 is an illustration of an example system and file structure currently available in the art to better explain the inventive concepts in the present disclosure. FIG. 1 and FIG. 2 are primarily provided as context to better explain the inventive concepts defined above and further described starting at FIG. 3.

More specifically, FIG. 1 illustrates layers in a stack 100 for a managed and accessible database 101. A managed and accessible database 101 is a comprehensive system designed to efficiently store, retrieve, and manage data while upholding stringent security and access control measures. Such databases are frequently found in complex applications and organizations that prioritize data integrity, reliability, and ease of access.

At the top of the stack 100 is the User Interface (UI) layer 103. This layer represents the entry point for users, clients, and third parties and serves as the front-end of the system. It encompasses graphical interfaces, web applications, and mobile apps, for example, allow users to interact with the database. The UI layer 103 ensures a user-friendly experience, enabling individuals to input, retrieve, and manipulate data seamlessly.

Below the UI layer 103 resides the Business Logic layer 105. This layer acts as the intermediary between the user interface and the database itself. It plays a pivotal role in data processing and manipulation, implementing the logic, rules, and algorithms that govern how data is handled. Various modules may run within this layer, each responsible for different aspects of data processing, such as data validation, calculations, and enforcement of business rules.

Beneath the Business Logic layer resides the Virtual Private Network (VPN) layer 107. This layer has a dual purpose within the system. Firstly, it establishes a secure and private communication channel for users and modules to interact with the database. Secondly, the VPN layer operates as a network load balancing cluster, distributing incoming requests across multiple servers or platforms. This redundancy ensures high availability and optimal performance, minimizing downtime and latency.

At the core of the system, we find the database 109 file structures 111. These structures determine how data is organized, stored, and retrieved within the database(s) 109 and how they can be protected. Different types of file structures 111 are employed based on the specific requirements and nature of the application.

Online Transaction Processing (OLTP) databases 113 are optimized for handling a high volume of transactions, often characterized by short and frequent operations, such as data inserts, updates, and deletes. These databases employ normalized data structures to minimize data redundancy and maintain data integrity.

In contrast, Online Analytical Processing (OLAP) databases 115 cater to complex queries and analytics. They are designed for read-heavy operations and frequently employ denormalized data structures to optimize query performance. OLAP databases 115 are particularly valuable for extracting meaningful insights from large datasets.

Within the realm of data warehousing, the Star Schema database 117 design is commonly employed. It is characterized by its division into fact tables and dimension tables. Fact tables contain metrics and numerical data, while dimension tables store descriptive information. This schema facilitates efficient querying for business intelligence and reporting purposes, enabling organizations to gain valuable insights from their data.

Another way to approach the layers in the stack is from bottom to top. At the bottom of the stack, you have the Data Storage Layer which may comprise the virtual private network 107 for a plurality of databases 109, and which is responsible for stored data. This layer includes various storage technologies, such as hard drives, solid-state drives, or cloud-based storage solutions. It ensures that data is persistently saved and retrievable.

Above the Data Storage Layer, you find the Data Management Layer and/or the Application layer, either of which may comprise core business logic 105, and which is responsible for managing data at a higher level. The system also may have a Database Management System (DBMS) like MySQL, PostgreSQL, or Microsoft™ SQL Server. The DBMS handles tasks like data organization, indexing, and query optimization. It ensures data integrity and provides mechanisms for data retrieval, insertion, and modification. The application layer in particular contains the software applications and services that interact with the database. These applications are designed to access, manipulate, and present data to users or other systems. They may include web applications, mobile apps, or backend services. At the top of the stack, you have the User Interface (UI) Layer 103.

A Security Layer permeates throughout the stack, ensuring that data is protected from unauthorized access or breaches. This includes authentication mechanisms, access controls, and encryption techniques to safeguard sensitive information.

The concept of a “managed and accessible database” emphasizes the importance of not only storing data but also efficiently organizing, securing, and providing controlled access to it through a well-structured technology stack. This ensures that data is a valuable and reliable resource for various applications and users while complying with relevant regulations and industry standards. As such, database file structures play a critical role in managing and accessing data within a managed and accessible database. These structures determine how data is organized and stored, impacting both data security through encryption and decryption and the efficiency of data retrieval, especially when working with encrypted data.

OLTP (Online Transaction Processing) databases 113 are designed to efficiently manage high volumes of transactional data, such as real-time data updates, inserts, and deletions. In OLTP databases 113, data is often organized into normalized structures, which minimize data redundancy and maintain data integrity. While OLTP databases 113 prioritize data consistency, they also have mechanisms for data encryption and decryption to safeguard sensitive information.

Encryption within OLTP databases is typically applied to specific data elements that require protection, such as personally identifiable information (PII), protected health information (PHI and other types of confidential and regulated information, such as financial data. Commonly, this encryption is implemented at the column level, allowing only so much granular control over which data is encrypted and what becomes available when the smallest encrypted unit becomes available. That said, symmetric encryption algorithms, like AES (Advanced Encryption Standard), are often employed for their efficiency in handling frequent data updates.

Decryption within OLTP databases 113 is performed automatically when authorized users access the encrypted data. The database management system (DBMS) handles decryption using encryption keys, ensuring that the data is presented in its original, unencrypted form only to authenticated users with the necessary privileges.

Searching encrypted data in OLTP databases 113 can be challenging due to the need to maintain data integrity while ensuring secure access. To address this challenge, databases often employ techniques such as deterministic encryption, which ensures that identical plaintext values yield the same ciphertext. This allows for the efficient retrieval of data using encrypted search terms without revealing sensitive information to unauthorized users. That said, encrypting and decrypting data in OLTP databases 113 can introduce a performance overhead, especially when dealing with high transaction volumes. Each encryption and decryption operation consumes computational resources, potentially slowing down transaction processing. Key management becomes more complex as the number of encrypted data elements increases. Moreover, although fine-grained encryption is desirable for sensitive data, it can lead to complexity and management challenges. Managing encryption keys and ensuring consistent encryption practices across various data elements can become cumbersome. Furthermore, searching encrypted data in OLTP databases 113 can be challenging. Deterministic encryption, which ensures identical plaintext values yield the same ciphertext, may limit the types of searches that can be performed, potentially hindering data retrieval flexibility.

OLAP (Online Analytical Processing) databases 115 focus on complex queries and analytics, making them well-suited for decision support and business intelligence applications. OLAP databases 115 often employ denormalized data structures for optimized query performance. While OLAP databases 115 prioritize read-heavy operations, they also incorporate encryption and decryption to protect the valuable insights stored within. Encryption in OLAP databases 115 follows a similar approach to OLTP databases 113 but may be applied differently based on the specific analytical requirements. Data encryption can be implemented at the column level, allowing for encryption of aggregated data points.

Decryption in OLAP databases 115 is essential for generating meaningful analytical results. Users and analytical tools must be able to access decrypted data to perform complex calculations and generate reports. Decryption is handled automatically by the DBMS, which decrypts data as needed during query execution.

Searching encrypted data in OLAP databases 115 is primarily focused on enabling efficient analytical queries. Techniques like index-based encryption can be employed, where encrypted data is indexed to speed up search operations. Additionally, parallel processing and distributed computing technologies may be used to enhance the speed of searching encrypted data across large datasets, ensuring that analytical insights can be derived swiftly. That said, OLAP databases 115 often deal with large-scale data warehousing. Encrypting and decrypting vast datasets can be resource-intensive, impacting query performance and response times, especially for complex analytical queries. Moreover, in OLAP databases 115, data is often aggregated for analysis. When data is encrypted, aggregating encrypted values may not yield meaningful results. Decryption is necessary to perform aggregations, which adds computational complexity. Furthermore, indexing encrypted data in OLAP databases 115 can be problematic. Traditional indexing methods rely on the order of values, but encrypted values appear random. Techniques like order-preserving encryption can compromise security. The flexibility to perform various types of queries on encrypted data may be limited. For example, performing range queries or wildcard searches on encrypted data can be challenging without revealing sensitive information.

Star Schema 117 is a specific database design commonly used in data warehousing environments. It consists of fact tables and dimension tables, facilitating efficient querying for business intelligence and reporting purposes. While Star Schema databases 117 emphasize data organization for analytical purposes, they also incorporate encryption and decryption to protect the sensitive data they contain.

In Star Schema databases 117, encryption is applied to both fact and dimension tables, as these may contain valuable insights and sensitive attributes. Encryption algorithms are chosen based on the security requirements and the volume of data being stored. Like OLAP databases 115, encrypted data in Star Schema databases 117 can be indexed to optimize search performance.

Decryption within Star Schema databases 117 ensures that analytical tools and reporting mechanisms can access meaningful data. As with OLAP databases 115, decryption is performed by the DBMS as part of the query execution process.

Searching encrypted data in Star Schema databases 117 is essential for generating insightful reports and dashboards. Indexing, parallel processing, and distributed computing techniques are often used to accelerate searches across the dimensions and facts while maintaining data security. That said, Star Schema databases 117 often involve complex dimensions with hierarchies. Encrypting and decrypting hierarchical data structures can be intricate, leading to increased query complexity. Moreover, queries in Star Schema databases often involve joining fact and dimension tables. Encrypting these tables separately can complicate the join process, requiring on-the-fly decryption during query execution. Furthermore, indexing encrypted data across dimensions can be challenging. While indexing within dimensions may be feasible, indexing across dimensions can be complex due to the need for coherent encryption methods.

Under certain circumstances, a security onion model may be employed by conventional systems. For example, a private server 119 holding database(s) may be operating. The private server 119 itself has security in place at the server level. Firewalls are employed to filter incoming and outgoing traffic, allowing only authorized communication to and from the private server. Network segmentation isolates the server from public networks, reducing exposure to potential attacks. Moreover, intrusion detection and prevention systems are implemented to monitor network traffic and detect any suspicious or unauthorized activities. They can trigger alerts or take preventive actions to mitigate security threats. That said, implementing encryption and decryption mechanisms at the Private Server Layer can introduce performance overhead. Encrypting and decrypting network traffic may slow down data transfer, especially in high-throughput environments.

The MySQL 121 Layer represents a common second tier of the security onion model. It focuses on securing the MySQL 121 database management system, which plays a central role in data storage and retrieval. A database firewall may be deployed to monitor and control SQL queries and requests and to help prevent SQL injection attacks and unauthorized access to the database. Role-Based Access Control may also be implemented to define and enforce granular access permissions within the MySQL database; users being assigned specific roles and privileges based on their responsibilities. That said, encrypting and decrypting data within the MySQL Layer can impact database performance, particularly for databases with heavy read and write operations. The overhead of encryption operations may lead to slower query response times. Moreover, searching encrypted data within the MySQL 121 database can be challenging. Traditional indexing and query optimization techniques may not work effectively with encrypted data, potentially leading to slower query execution.

In the third layer, specific database instances 123 or schemas instantiated within the MySQL 121 server may be implemented and the table(s) 125 themselves may be encrypted and secured. Balancing data granularity with security can be challenging. Over-encryption can hinder data analysis and reporting, while under-encryption may expose sensitive information. Striking the right balance is crucial. Furthermore, searching encrypted data within encrypted tables is one of the most challenging aspects. Traditional database queries may not work as expected because the data is encrypted. Redacting sensitive information within encrypted tables can be complex. Striking a balance between data protection and usability is a challenge, especially when users need access to partially redacted data. Furthermore, the table(s) 125 and others like it may be part of a MongoDB, which is object based and which treats table(s) 125 as the smallest encryption unit. This is not acceptable for compliance regimes.

Referring now to FIG. 2, an illustration of an example blockchain (node) architecture currently available in the art to better explain the inventive concepts in the present disclosure is shown.

Serialization refers to the process of converting data structures or objects into a format that can be easily stored, transmitted, or reconstructed. In the context of blockchain, this often means converting data into a linear format for storage and transfer.

A blockchain 200 is a distributed and immutable digital ledger that records transactions across a network of computers. A blockchain protocol defines the rules and procedures for how transactions are validated, added to the blockchain 200, and maintained. It typically involves a consensus mechanism and cryptographic techniques. Serialization in a blockchain 200 means that transactions are processed in a specific order and added to the blockchain 200 in a linear, chronological sequence. This ensures that there is a clear history of transactions, and no two conflicting transactions can be added simultaneously. When transactions are serializable, it means they are carried out one after the other, as if they were processed in a sequential order, even if they are executed in parallel.

Blockchain protocols often use consensus mechanisms (e.g., Proof of Work or Proof of Stake) to determine the order in which transactions are added to the blockchain 200 and define the rules and procedures that govern the behavior of a blockchain network. In particular, the protocol specifies how nodes in the network agree on which transactions are valid and in what order they should be added to the blockchain 200. Different blockchains 200 use various consensus mechanisms to achieve this, such as Proof of Work (used by Bitcoin™) or Proof of Stake (used by the Avalanche™ subnets). It also defines the structure of each block 202 in the blockchain 200, including how transactions are grouped together and how references to previous blocks 202 are maintained (e.g., through a cryptographic hash). Cryptographic hashes, digital signatures, and encryption methods are commonly employed. Moreover, blockchain protocols specify how nodes in the network communicate and propagate new transactions and blocks 200. This often involves a peer-to-peer network architecture. Furthermore, some blockchain protocols, like Ethereum™, support smart contracts. These are self-executing contracts with predefined rules and conditions that automatically execute when certain criteria are met.

SHA-256 is a commonly used cryptographic hash function used to verify data integrity. When data is transmitted or stored, a hash of the data is computed. If the data changes in any way, even by a single bit, the resulting hash will be dramatically different. By comparing the original hash with the recalculated hash, one can detect whether the data has been tampered with during transmission or storage.

Blockchain 200 nodes are integral components of a blockchain network. They are individual devices or computers that participate in the network by validating, storing, and propagating transactions and blocks 202. Nodes play a critical role in maintaining the decentralized nature of blockchain technology.

The nonce 204 is a unique and arbitrary number that miners in a Proof of Work (PoW) blockchain network must discover through computational work when they attempt to add a new block 202 to the blockchain 200. Miners repeatedly alter the nonce value until they find one that, when hashed along with the block's 202 content, produces a hash that meets the network's difficulty criteria. The nonce 204 serves as a mechanism to make block 202 creation computationally challenging and ensures that miners invest real computational power in securing the network. In a Proof of Stake (POS) blockchain network, a nonce 204 typically refers to a value used in the process of creating a new block 202. However, it's essential to note that the concept of nonce 204 can vary slightly depending on the consensus mechanism used.

More specifically, in proof of work (PoW) systems, the nonce 204 is a random value that miners adjust when attempting to solve a cryptographic puzzle to find a valid block hash. The miner repeatedly hashes the block header with different nonce 204 values until they find one that results in a hash below a certain target threshold, thereby proving that computational work has been done.

In a PoS network, where the consensus is achieved through (for example) validators staking their cryptocurrency holdings rather than solving computational puzzles, the role of the nonce 204 may differ. Instead of being used to solve cryptographic puzzles, the nonce 204 in a PoS network could serve other purposes, such as ensuring the uniqueness of block hashes or helping to determine the order of transactions within a block 202.

A transactionID 206, also known as a trxID 206, is a unique identifier assigned to each transaction on the blockchain. It is typically generated using a cryptographic hash function, such as SHA-256, applied to the transaction data. The trxID 206 allows anyone to verify the existence and details of a specific transaction on the blockchain 200, making it crucial for transparency and auditability.

Each block 202 in a blockchain 200 is assigned a unique block number 208, starting from the genesis block 202 (Block 0) and incrementing sequentially as new blocks 202 are added. Block numbers 208 serve as a chronological order of blocks 202 in the blockchain 200, helping nodes and users track the history of transactions. They also provide a reference point for locating specific transactions or blocks 202.

Dates 210 or timestamps are associated with each block in the blockchain, indicating when the block was added to the chain. These dates 210 help establish the order of blocks 202 in the blockchain 200 and ensure that transactions are processed in a time-sequential manner. They also play a role in ensuring the network's security, as blocks 202 with incorrect dates 210 or timestamps may be rejected by nodes.

Storing personal, confidential, or private information (e.g., compliance regime type data as described herein) within a blockchain's node and chain architecture introduces a range of complexities, challenges, and potential deficiencies. While blockchain technology offers certain security advantages, it may not always be the optimal choice for sensitive data, especially when considering encryption, decryption, and searching encrypted data.

The immutability of the node-chain architecture poses a significant challenge when it comes to personal data. Once data is recorded on the blockchain, it cannot be easily deleted or modified. This conflicts with data protection regulations, such as GDPR, which require the right to delete one's data, and foreign law which affords certain nationals the right to be forgotten.

Moreover, encrypting and decrypting data within a blockchain can be complex. While encryption can provide confidentiality, it adds computational overhead, potentially slowing down data retrieval and validation processes. This is especially problematic for high-throughput applications. For example, storing large volumes of personal information, especially in a healthcare context with numerous patient records, can lead to increased transaction costs, slower processing times, and reduced network efficiency. Moreover, while data at rest can be encrypted, data in transit between blockchain nodes and the user's device must be decrypted for viewing. This introduces potential vulnerabilities during the decryption process, making data exposure possible. Traditional database indexing and search mechanisms also do not work well. Complex cryptographic techniques like homomorphic encryption or secure multi-party computation are required, introducing computational overhead and complexity.

With the above context in mind, systems and methods according to the present disclosure address and overcome one or more of the shortcomings and drawbacks of conventional systems and methods by building in heightened data access controls, traceability, and deidentification at the data architecture foundation, via key-based cryptography and separate storage of identity and digital transaction content, with compliance authentication hashed onto a permissionless distributed ledger, and granting fine-tuned data access and use permissions on a need-to-know/need-to-use basis via allocation of cryptographic keys.

Referring now to FIG. 3, an illustration of example hardware that is useful for the inventive concepts according to the present disclosure is shown. In particular, a scalable Beowulf cluster 302 configured to use a 64-bit architecture and multithreading and operates as a network load balancing cluster is shown. In one aspect, the Beowulf cluster 302 incorporates an over clocked hyper virtual machine that is bifurcated across three subnets but that is scalable N+1. In one aspect, the Beowulf cluster 302 is a 2.5 petahash array. In a real-world example, metrics showed that the Beowulf cluster 302 could handle 270 stored procedures with each one completed in between about 4 milliseconds to about 12 milliseconds.

A Beowulf cluster 302 is a type of computer cluster designed for parallel computing or distributed computing tasks. It typically consists of commodity hardware (standard off-the-shelf computers) interconnected via a local area network (LAN). Nodes work together to solve computationally intensive tasks in parallel. A multithreaded system is one that can execute multiple threads or processes concurrently. In certain instances, the cluster's computational power is measured in petahashes per second (PH/s). Petahash is a unit of measurement for the processing power of mining hardware.

Each node in the Beowulf cluster 302 is equipped with specialized hardware for cryptocurrency mining, such as application-specific integrated circuits (ASICs) or graphics processing units (GPUs). These hardware components are optimized for hash calculations. Moreover, the cluster incorporates load balancing mechanisms, which can be implemented through hardware or software load balancers. These mechanisms distribute incoming network traffic (e.g., mining pool requests, data transfer) among the nodes in a balanced manner.

The Beowulf cluster 302 operates as a network load balancing cluster. A network load balancing cluster is a group of servers or nodes that work together to distribute incoming network traffic across multiple servers. As shown in FIG. 3, the Beowulf cluster 302 directs incoming network traffic to different nodes within the cluster to balance the computational load and ensure efficient mining operations. This distribution helps optimize resource usage, improve fault tolerance, and ensure high availability of services.

Scalability refers to the ability of a system or cluster to handle increased workloads or growing demands by adding more resources, such as nodes or hardware components. As shown in FIG. 3, the Beowulf cluster is designed to accommodate future growth in computational power for cryptocurrency mining. It can easily expand by adding more nodes to increase its petahash processing capacity. Subnets are logical divisions of an IP network. They are defined by subnet masks and enable the segmentation of a larger network into smaller, manageable segments.

Moreover, the cluster incorporates the use of virtualization technology, such as hypervisors (e.g., VMware, Hyper-V), to create and manage virtual machines (VMs) within the cluster. These VMs can run multiple operating systems or applications in isolation from one another. The cluster is configured with a minimum of three separate subnets, or network segmentations, which serve various purposes, such as isolating different parts of the cluster, improving network security, or optimizing network traffic management.

Furthermore, the cluster has centralized management and monitoring tools that allow administrators to oversee the status and performance of individual nodes, as well as the load balancing process. In particular, the centralized management tools allow for monitoring of method request and/or platform instruction as well as the use of cryptographic tools like SALTs and keys.

A note on overclocking is that it requires precise control of voltage, cooling, and stability testing. Temperature monitoring and cooling solutions, such as liquid cooling or high-performance air cooling, may be crucial to prevent overheating.

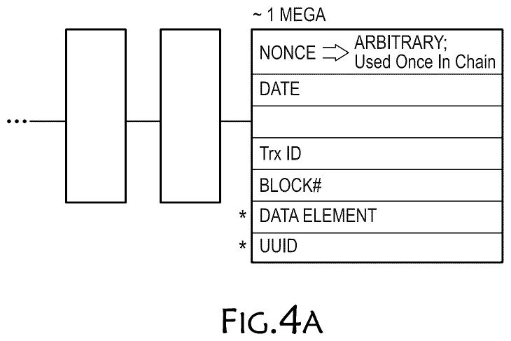

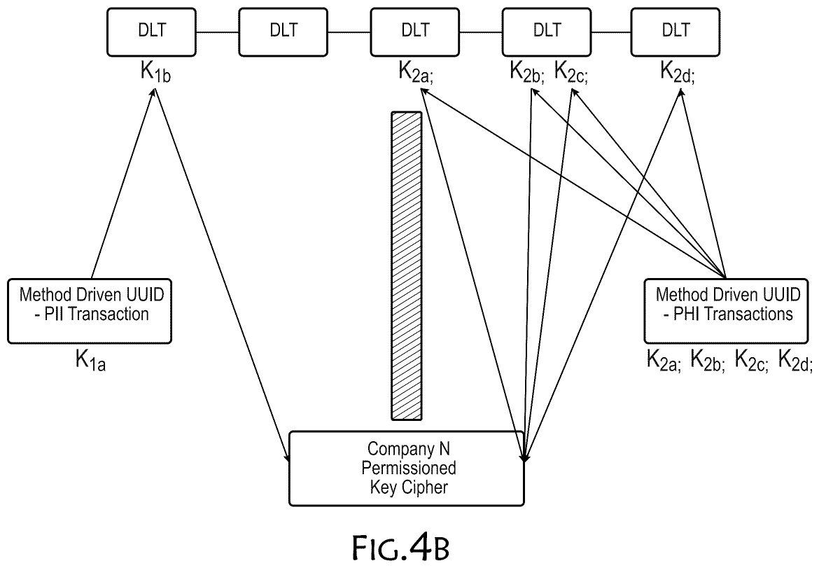

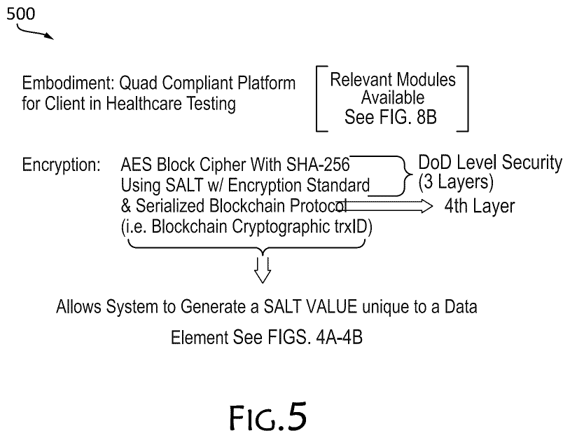

Referring now to FIGS. 4A and 4B, an illustration of an example blockchain (node) architecture used according to the present disclosure is shown. Data segmentation and data security are at the heart of the inventive concepts described herein. The ability for a participant to direct the decryption of their own personally identifiable information (for example, PII) and confidential information (and associated data or metadata or transaction data) for example, PHI), alongside a secondary decryption of the confidential information (or associated data or metadata or transaction data) (for example, PHI), across multiple compliance regimes, is a fundamental challenge.

For simplicity, the following example is focused on U.S. health data and the overarching compliance regime(s) over it. The disclosure is not limited to this industry or to this compliance regime(s). The example resolves these challenges to managing health data as shown in FIG. 4B by:

Physically segmenting two relational database management system (RDBMS) objects (using HIPAA acronyms: personally identifiable information (PII) and protected health information (PHI)).

Providing masking universal unique identifier (UUIDs), providing the first level of deidentification to the participant and their data within the system.

Only allowing the UUID of the PII to link to PHI. The PHI can remain encrypted despite the link between the physically segmented RDBMS objects. The UUID is the participant's credential.

Next, selecting the PII selects the public distributed ledger technology (DLT) key from the block and transactionID, returning two items, the JavaScript Object Notation (JSON) meta data, describing the transaction set, and the block number that was solved.

Within the data architecture, decrypting requires: the Participants UUID based encryption key and the slated PHI's UUID based encryption key, which essentially operates as a conventional cryptographic key model for decryption, and which at this point does nothing yet to expose or make vulnerable the PPH.

Within the data architecture, activities (methods) are serialized at the transaction level, so retrieving both private keys (the UUID participant and the UUID PHI) and the tertiary public key, which is a combination key of the transactionID and block number, allows the system to decrypt the sensitive data payload.

The transaction flow of data in the above example occurs as follows: for the PII Side:

Data is stored in a physically separated PII data object.

The transaction driven event is abstracted with its UUID-which is sent to a public DLT with a JSON object descriptor.

The public key is stored within the cipher according to the present disclosure, as on an independent transaction.

For the PHI Side:

Data is stored in Physically separated PHI data object.

The Transaction driven event is abstracted with its UUID-which is sent to a public DLT with a JSON object descriptor.

The public key is stored within the cipher according to the present disclosure, as on dependent transaction with encrypted UUID.

The decryption process in this example is as follows:

To read a single side of the of UUID key pair, the permissioned platform method reads the PII UUID, then matches with the DLT key, which is then leveraged to decrypt only the corresponding cipher keys.

Next, a similar process is executed on the PHI side.

It is only when both tertiary key decryptions have successfully been achieved that plain text data payload can be rendered and returned through the permissioned method.

The method processing steps in the above example are as follows:

K1a—The capture and private key encryption of individual identity data secured by a stored via a zero-knowledge proof UUID.

K1b—The private key (UUID) of the rest data, transaction being signed to its corresponding public key. Thus, creating an immutable, publicly visible date/time stamp of its creation as well as providing the second portion of the triple data encryption standard encryption key.

K2a—The unique activity (executed within the architecture) that is tied to the above mentioned UUID; then having an activity base UUID generated for the activity type; providing it zero knowledge proof, and then generating it's corresponding public key.

K2b; K2c; K2d—These additional unique activities (also executed within the architecture) continue to follow the above-mentioned process; are stand alone as they relate to the identity UUID; standalone from any interdependence to previous or post unique activities; each maintain their own unique adherence to compliance regimes.

Referring now to FIG. 5, an illustration of an example encryption/cipher useful for a quad compliant application for a participant(s) using the system in Healthcare Testing, for example, according to the present disclosure is shown.

Generally, according to the broad inventive concepts, the public key cryptography is provided to the architecture via an additional segmentation, i.e., via segmentation of additional encryptions keys via a subnet architecture limiting the visibility of the application activity to its own public key subnet. Although there may exist cross subnet bridging, its sole purpose is to query the JSON based attributes for qualitative analysis and does not interact with the identity subnet. Any deidentification of an activity is controlled and processed within the architecture. The decryption mechanism described herein, then, is successful when all three keys have been processed via a proprietary decryption cipher mechanism, allowing the underlying data to be presented in a readable format to the participant, or to third parties only when permissioned by the system/participant to have access to the most granular level of PII or PPH fed into the system. The system is infinitely extendable and every layer of granularity (e.g., any attribute to any object or any associated “stuff” to any essential entity handled by the system via the application) can be encrypted and made selectively accessible as needed (unlike for example MongoDB™; see FIG. 1).

Multiple modules for various different clients of the system (e.g., (1) one for Healthcare Testing companies like QUEST™ reporting medical test results to participants and/or third-parties; (2) one for Internal Review Boards for the Clinical Testing of medication or medical equipment or device; (3) one for Employer-Hired Wellness Screening Companies doing qualification for Employer-provided healthcare benefits; (4) one is for Public Entities doing Employee Drug Screenings; and (5) one is for General Practice/Specialist Doctor Practices, etc.) are available to operate on the application and, depending on the participant (highest level; full access)/users accessing the application via the module, the permissions or roles available through each module may be mixed. In one aspect, depending on the permission or role and the compliance regime, for example, the system is capable of finding and selectively granting access to the most granular data possible (even if part of the same table, column, row, metadata table, extension table, etc.) while keeping encrypted or hidden all other non-relevant, non-permissioned granular data possible (even if part of the same table, column, row, metadata table, extension table, etc.)

As shown in FIG. 5, in one aspect according to the present disclosure, the cipher 500 is a combination of an AES block cipher with SHA-256, wherein two additional elements play a role: a SALT encryption standard and a serialized blockchain protocol. Generally, an AES block cipher with SHA-256 and SALT encryption standard is Department of Defense level security providing the synergistic combination of the three security layers (e.g., RSA, SHA, and SALT). By combining the serialized blockchain protocol as a 4th layer (e.g., leveraging blockchain cryptographic trxID(s)) with the three-layer RSA Signature protocol with SHA-256 and SALT, the resulting synergistic combination allows the system to generate a SALT identifier unique to a data element, and that unique ID facilitates in the secure segmentation of PII, PHI, and PLATFORM permissioning. In another aspect, the combination according to the present disclosure allows for a relation to be established between subnet(s) and data payload(s) so that the system can identify in both directions.

In another aspect, the SALT is dynamic in that the system leverages trxID(s) at proof of resolution (e.g., post proof of stake resolution).

In another aspect, the system yields a serialized independent chain by payload element.

In another aspect, still referring to FIG. 5, decryption of information by the system includes the mandate of reading the subnet information (e.g., for keys). In another aspect, identifier key(s) exist between the DATABASE tables and the subnet(s). In another aspect, the same UUID and the decryption key may be within a table (e.g., IRBCONTENT). In another aspect, when the cipher is pulling back from the correct subnets, the UUID is obtained from IRBCONTENTS and then the PII key is obtained to read aspects of the relevant object or data element. In another aspect, the UUID from TESTKITS for example is obtained and then the PHI key is obtained to read all the relevant aspects. In another aspect, AES is then employed to decrypt off a SALT using the obtained keys.

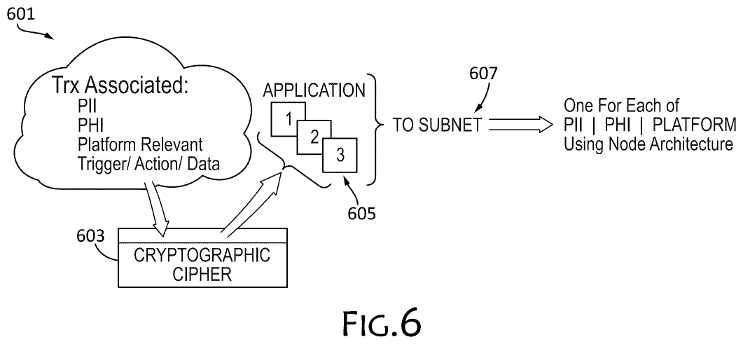

Referring now to FIG. 6, an illustration of an example use of subnets according to the present disclosure regardless of the number of platforms using the cryptographic cipher is shown. Transactions 601 associated with PII, PHI, PLATFORM, and/or SYSTEM/APPLICATION Triggers/Actions are processed with/through the cryptographic cipher 603, and the resultant is made available for use by one or more applications 605. The application(s) then may communicate with the subnets 607 (one for each of PII, PHI, and PLATFORM). However, no PII or PHI is stored on protocol.

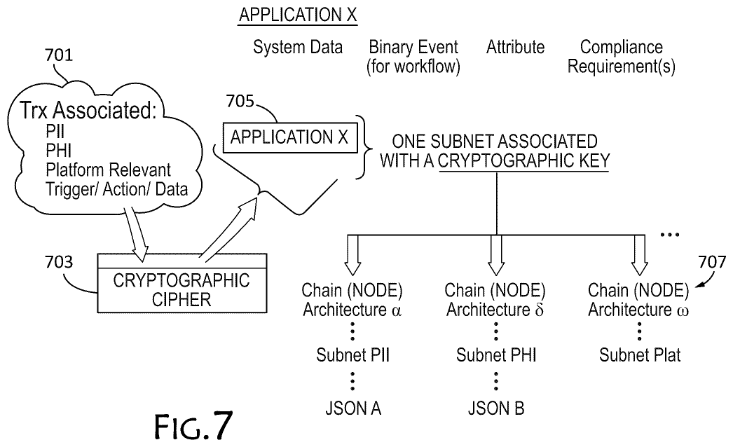

Referring now to FIG. 7, an illustration of an example of one application according to the present disclosure is shown. In one aspect according to the present disclosure, each subnet is associated with a cryptographic key. In another aspect, the JSON metatags for one subnet may be different from the JSON metatags of another subnet (e.g., A does not equal B). In another aspect, the JSON metatags for one subnet may be the same as the JSON metatags of another subnet (e.g. A equals B). In one aspect, the JSON metatags may be client/module specific and may be directed by the client. In another aspect, the JSON metatags may be managed by a relational database management system (RDBMS).

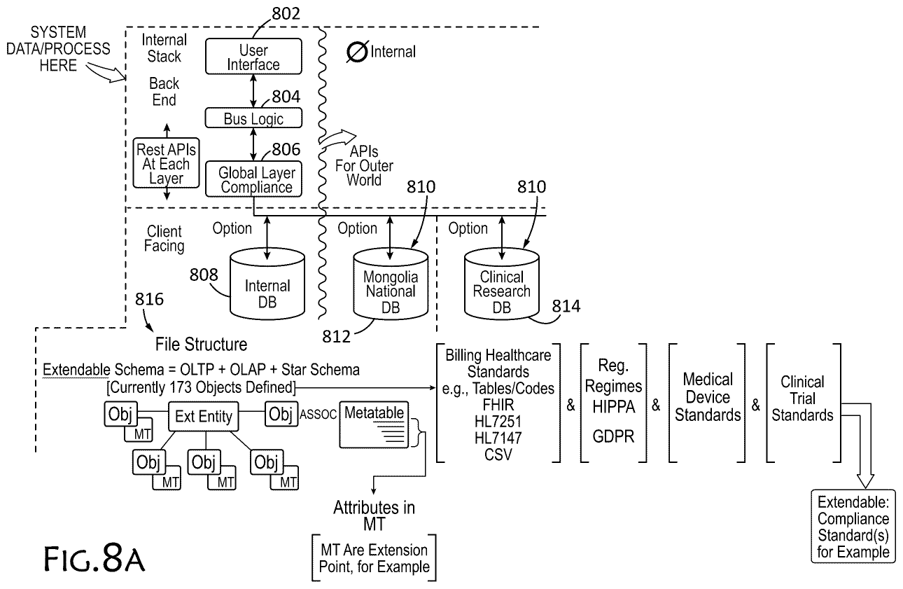

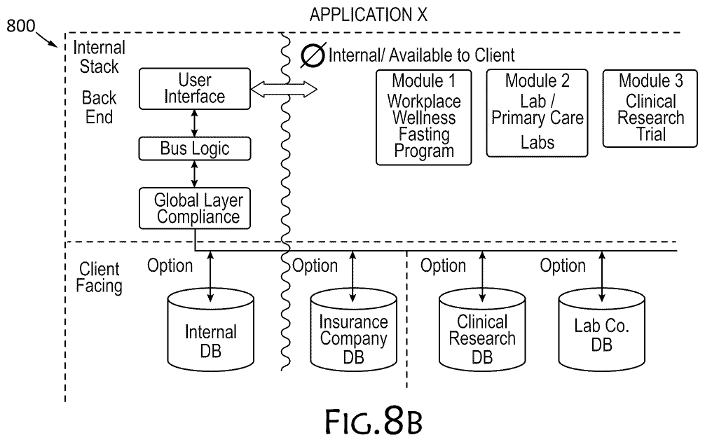

Referring now to FIG. 8A, an illustration of an example system and layers in the stack according to the present disclosure is shown. The internal stack includes the user interface 802, the business logic 804, the global compliance layer 806, and an internal database 808 (that can be client facing to allow for client access and monitoring of encrypted information stored therein) but the system is not limited to these layers. APIs exist for the outside world, and Representational State Transfer (REST) APIs exist at each layer in the back end, which means that no change in code is needed if changes are requested by the clients. In particular, the back end allows for modifications to the way the system handles transactions, if dealing with dynamic workflows. In one aspect, if dealing with dynamic workflows, the back end allows for configurations changes. In another aspect, system allows for modifying, or jumping out of or jumping around a transaction.

The stack is built based on Quality Management System (QMS) standards. QMS is a structured framework and set of processes designed to ensure that an organization consistently delivers products or services that meet or exceed customer expectations. The primary goal of a QMS is to achieve and maintain high levels of quality, efficiency, and customer satisfaction. In particular, the stack focuses on QMS in the following areas: insulation, operation, and production, and in certain instances goes through the same qualification process as any pharmaceutical or medical device in the U.S.A.

As mentioned above, the stack includes an internal database 808 that in one aspect is client facing (e.g., internally operated and managed but the client can monitor or audit). Along with the internal database 808, other non-internal databases 810, such as external databases possessed by third party entities or nations, for examples, are part of the system. In this way, the system allows for databases to be held in foreign nations or in particular locations, and/or for them to be operated and/or managed/monitored by the third party. For example, a database in the stack may be the Mongolian National Database 812 and a clinical research database 814. The global compliance layer 806, for example, can operate across all these databases (in particular, those not internal or back end) to store encrypted data using the file structure according to FIG. 8A for example.

In one aspect, a file structure 816 according to the present disclosure is a combination file structure of OLTP+OLAP+Star Schema, wherein extendable entities have related objects each associated with metatable(s). In another aspect, determined attributes are placed in the metatables for associated objects. In another aspect, the metatables are extension points for the file structure.

In one aspect, the file structure has 173 or more defined objects which are mapped to, for example: billing or healthcare standards, e.g., billing codes and tables, Fast Healthcare Interoperability Resources (FHIR) standard; regulatory regimes, e.g., HIPAA, GDPR; medical device standards. The objects are extendable to, for example, mapping to other compliance regimes.

In one aspect, client access/use to the file structure and use of the encryption cipher are each their own individual billable/commercializable product. In another aspect, client access/use to portions of the file structure for billing or healthcare standard, regulatory regimes, medical device standards, and/or any other compliance regime, are each their own individual billable/commercializable product.

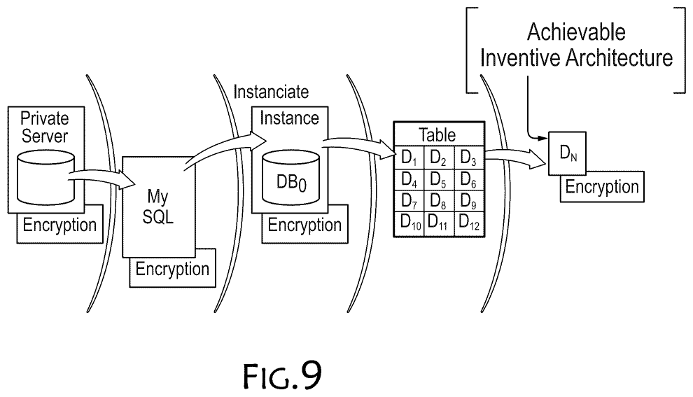

Referring now to FIG. 8B, an illustration of an example application and the modules running on the application according to the present disclosure is shown. In particular, an application 800 having layers in a stack for a billing product is shown. Multiple modules for various clients of the system are available to operate on the application and, depending on the participant (highest level; full access)/users accessing the application via the module, the permissions or roles available through each module may be mixed. In one aspect, depending on the permission or role and the compliance regime, for example, the application 800 is capable of finding and selectively granting access to the most granular data possible (even if part of the same table, column, row, metadata table, extension table, etc.) while keeping encrypted or hidden all other non-relevant, non-permissioned granular data possible (even if part of the same table, column, row, metadata table, extension table, etc.) (see FIG. 9) even if the database in not internal to the stack and possessed and/or operated by a third party.

Referring now to FIG. 9, an illustration of an example of achievable inventive architecture according to the present disclosure is shown. In particular, the system is capable of by data element encryption. In another aspect, the system is capable of by data element SALT encryption.

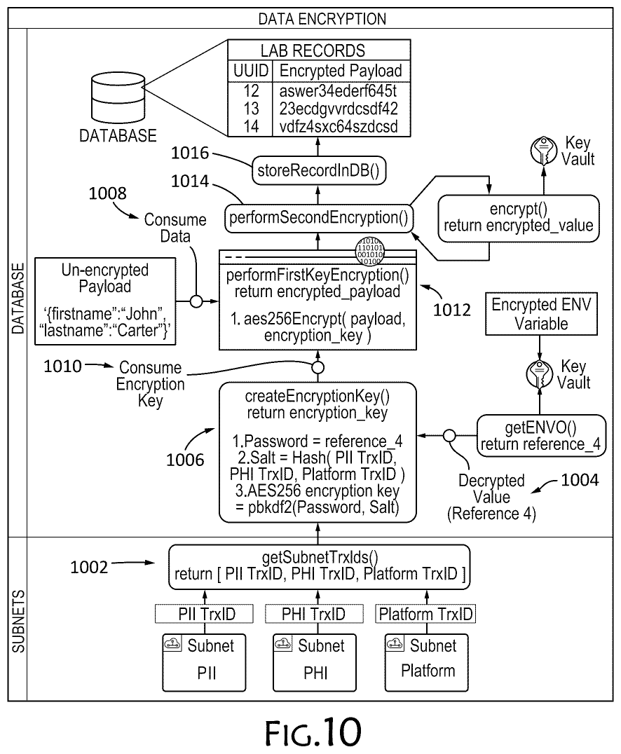

Turning to the examples of FIGS. 10-13: FIG. 10 is an illustration of an example schematic flow diagram for a process of encrypting an unencrypted data payload according to the present disclosure. As shown by the figure, at 1002, the transactionIDs associated with the data payload are retrieved. In general, a single data payload may be associated with transactionIDs from multiple subnets, including the PII subnet, the PHI subnet, and the platform subnet. Broadly speaking, prior to 1001, the unencrypted data payload was received by the system and divided across the three subnets, as appropriate, and then submitted to the three subnets as transactions (producing the transactionIDs).

Next, at 1004, the environment variable for the encryption system is retrieved. Then, at 1006, the first encryption key for the data payload is created. As shown in the figure, the encryption key is created by first generating a hash value from the transactionIDs using SHA-256. Because of the nature of the hashing algorithm, this hash is thus uniquely tied to the three sub-transactions spread across the PII subnet, the PHI subnet, and the platform subnet. This hash is then utilized alongside a secure environmental variable to generate a (later recoverable) key to encrypt the data payload. This key is referred to as the first encryption key.

Next, at 1008, 1010, and 1012, the data payload is encrypted with the first encryption key serving as the encryption key. Specifically, the unencrypted data payload is used as the plaintext input to the AES-256 encryption algorithm, with the first encryption key used as the key for the AES-256 encryption algorithm. Once complete, the ciphertext output of the algorithm servers as the encrypted data payload, with the unencrypted data payload being securely discarded. Subsequently, at 1014, the encrypted payload is encrypted a second time with a second encryption key. Lastly, at 1016, the now encrypted data payload is stored in the database.

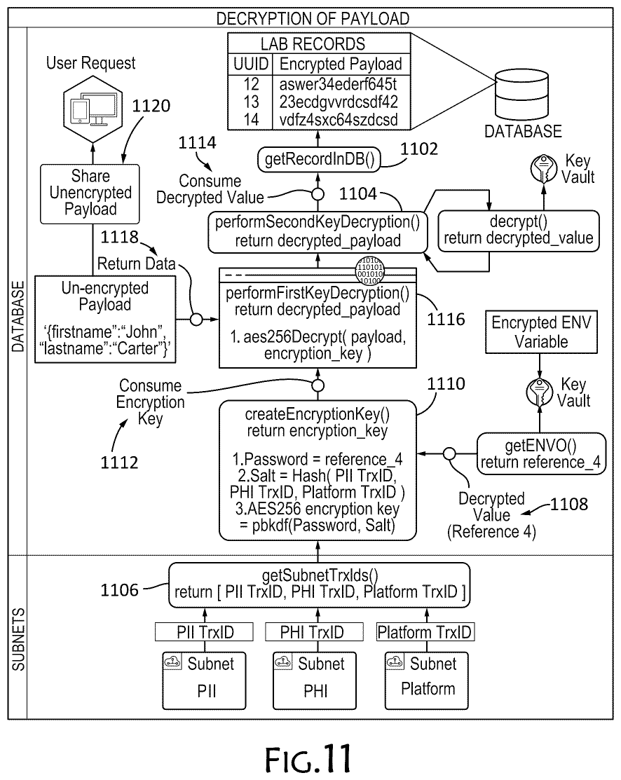

FIG. 11 is an illustration of an example schematic flow diagram for a process of decrypting an encrypted data payload according to the present disclosure. As shown by the figure, at 1102, a chosen encrypted data payload is retrieved from the database. Next, at 1104, the encrypted data payload is decrypted using the second encryption key. Then, at 1106, the transactionIDs associated with the data payload are retrieved. In general, a single data payload may be associated with transactionIDs from multiple subnets, including the PII subnet, the PHI subnet, and the platform subnet. Next, at 1108, the environment variable for the encryption system is retrieved.

Then, at 1110, the first encryption key for the data payload is recovered. As shown in the figure, the encryption key is regenerated by first generating a hash value from the transactionIDs using SHA-256. Because of the nature of the hashing algorithm, this hash is thus uniquely tied to the three sub-transactions spread across the PII subnet, the PHI subnet, and the platform subnet. This hash is then utilized alongside the secure environmental variable to regenerate (and this recovers) the key used to encrypt the data payload—i.e., the first encryption key.

Subsequently, at 1112, 1114, and 1116, the encrypted data payload is decrypted with the first encryption key serving the decryption key. Specifically, the encrypted data payload is used as the ciphertext input to the AES-256 decryption algorithm, with the first encryption key used as the decryption key for the AES-256 decryption algorithm. Once complete, the plaintext output of the algorithm servers as the decrypted data payload. Lastly, at 1118 and 1120, the unencrypted data payload is then returned as the response to the user's request.

FIG. 12 is an illustration of an example schematic flow diagram for a process of storing encrypted data such that it can be searched without being decrypted according to the present disclosure. As shown in the figure, at 1202, when a data payload is received from a user for storage, the contents of the data payload are converted to all lower case. In general, a data payload may contain multiple records, which are each handled separately. Then, as shown at 1204, for each record in the data payload, for each of the PII subnet, the PHI subnet, and the platform subnet, the salts associated with the subnets for that record are retrieved. Next, as shown at 1206, these salts, along with the converted records of the data payload, are then used as the input to a hashing algorithm (e.g., SHA-256) to generate a unique hash. Specifically, each of the converted records are hashed independently. Subsequently, at 1208, the UUIDs associated with the subnet transactions associated with the records of data payload are retrieved (not shown). The generated hashes are then stored alongside the retrieved UUIDs in a database.

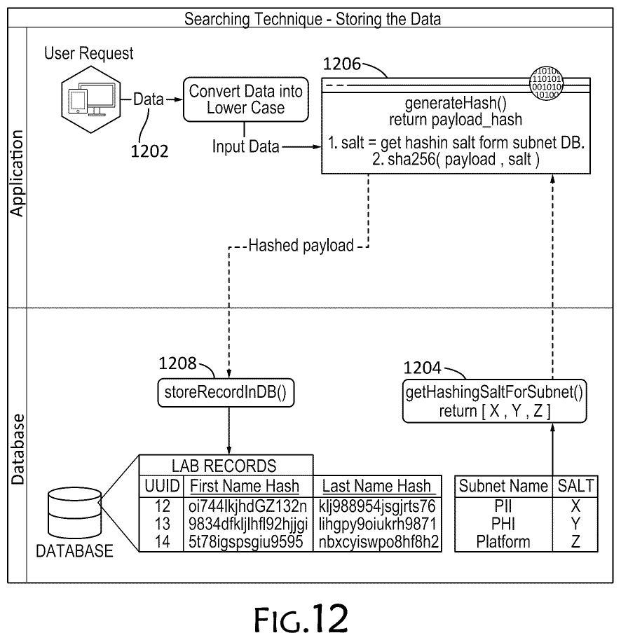

FIG. 13 is an illustration of an example schematic flow diagram for a process of searching encrypted data without decrypting the encrypted data according to the present disclosure. As shown in the figure, at 1302, when a search request is received from a user, the search contents are converted to all lower case. Then, as shown at 1304, for each record in the data payload, for each of the PII subnet, the PHI subnet, and the platform subnet, the salts associated with the subnets for that record are retrieved. Next, as shown at 1306, these salts, along with the converted records of the data payload, are then used as the input to a hashing algorithm (e.g., SHA-256) to generate a unique hash. Subsequently, at 1308, the generated hash is compared against the hashes stored in the database. If a record is found, as shown at 1310, the associated UUID is retrieved. Subsequently, each retrieved UUID is used to retrieve an associated encrypted data payload (not shown). This encrypted data payload is then decrypted (e.g., as described above in FIG. 11), and as shown at 1312, the unencrypted data payload is then returned as the response to the user's search request.

In a first embodiment, as described above, a user may submit new information (i.e., a first data payload) to the system for storage. The system may then generally function as described in FIGS. 10 and 11 to store the provided new information. In particular, after the transactionIDs are created, the transactionIDs may be utilized to encrypt the provided information. This may secure the provided information in a way uniquely tied to the associated transactions, linking the data to the associated transactions, in a secure and confidential manner. Alongside the encryption process, the new information may also be processed to generate a searchable hash. In particular, the transactionIDs, alongside the subnet salts, may be used to generate a hash that is uniquely tied to the hashed information, but which does not indicate the contents of the hashed information (i.e., a one-way function). This information may then be stored alongside the encrypted transaction. A benefit of providing this encrypted hash is to allow for the encrypted information to be searched without requiring the information to first be decrypted (and thus be potentially exposed).

In a second embodiment, as described above, a user may search stored encrypted information without first decrypting the stored information. The system may then generally function as described in FIG. 13 to search the encrypted data payloads stored by the system. In particular, a user may provide a first data query, such as a text string. This first data query may be processed into a desired form—e.g., all lowercase—and then used to create a query hash. Because the query hash is generated in the same manner as the searchable hashes, any data that matches the string being searched for would also generate an identical hash. Thus, by comparing the query hash to stored searchable hashes, any matches indicate a stored transaction with the requested search string. A benefit of this process is that searching is enabled without requiring the underlying information to be revealed. While a matching hash does affirmatively indicate the underlying data is the same as the string being searched for, the nature of hashing algorithms means it is computationally infeasible to use this property to reveal the underlying information for an arbitrary stored hash.

In a third embodiment, as described above, a user may submit request information stored by the system. The system may then generally function as described in FIG. 11 to retrieve the stored information. In particular, after the UUID (i.e., row ID) of a stored encrypted record, the transactionIDs associated with the record may be retrieved and used to regenerate the key used to encrypt the stored record. The recovered key may then be used to decrypt the stored record, recovering the initial plaintext originally provided to the system for storage. The system may then provide this information back to the user in response to the user's request.

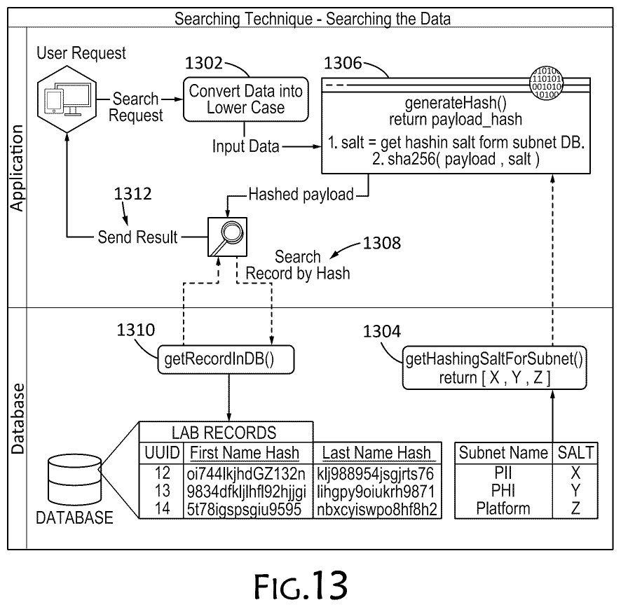

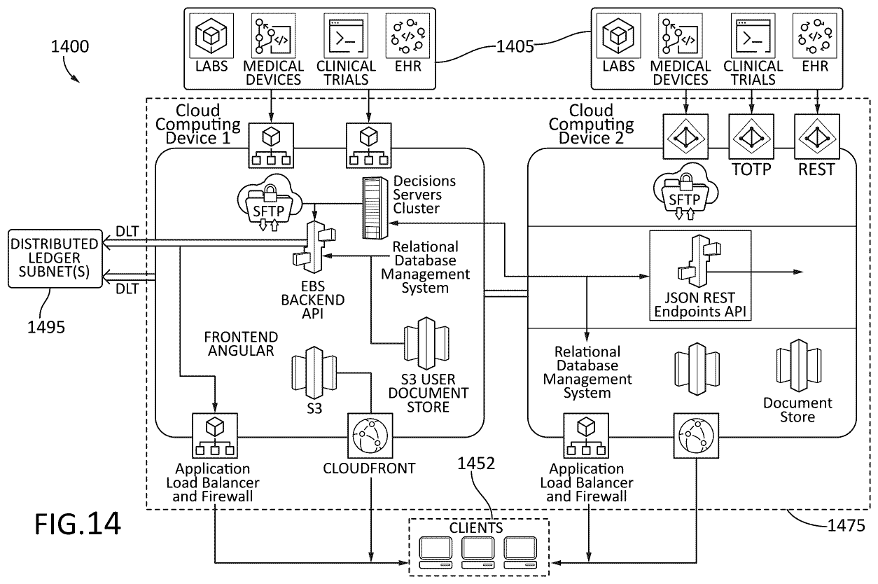

FIG. 14 is a schematic illustrating an example system architecture used to carry out the operations discussed herein, according to the present disclosure. In particular, in FIG. 14, a system diagram 1a400 is shown in accordance with various embodiments for managing healthcare data. As shown, the computing device(s) 1452, the data management system 1475, the distributed ledger subnet(s) 1495, and/or the like.

In one aspect, the data management system 1475 may use one or more cloud computing services, such as Amazon Web Services™, Microsoft™ Azure, Google™ Cloud, and/or the like. As such, the data management system 1475 may communicate with such cloud computing services via the network 1400. In various embodiments, unless otherwise stated, the operations carried out by a cloud computing service may be considered as carried out by the data management system 1475 (e.g., the data management system 1475 may direct the processing completed by the cloud computing services). Additionally, the data management system 1475 may include one or more cloud devices (e.g., supported by a cloud computing service).

In another aspect, the data management system 1475 may receive data packets 1405 (e.g., a first data packet, a second data packet, a third data packet, etc.) with information relating to one or more users. The data packets may include health data, such as PII, PHI, and/or the like. Example data packets 1405 may be received from various sources. For example, a data packet may be received from a lab (e.g., patient information, test results, etc.), a medical device (e.g., device information, device test readings, etc.), a clinical trial (e.g., participants, results, etc.), an electronic health record (EHR), and/or the like. As discussed herein, health data is merely an example area of data in which the operations discussed herein may be used. As such, the data packets may be received from various different sources and processed by the data management system 1475.

The data management system 1475 may receive and process the data packets 1405 as discussed herein. As such, the data management system 1475 may receive the data packets 1405, determine a data type (e.g., PII, PHI, platform, etc.) for the data packets and determine one or more users associated with the data packets. The data management system 1475 may include multiple cloud computing devices (e.g., provided via multiple cloud computing services). For example, FIG. 14 illustrates two cloud computing devices operating together to carry out the operations herein. Alternatively, a single cloud computing device may carry out the operations discussed herein. In some embodiments, non-cloud computing devices may be used in place or in communication with the cloud computing devices. For example, the data management system 1475 may be a dedicated computing device.

In various embodiments, the data management system 1475 may encrypt the data packets 1405. The encrypted data packets may be stored in a database. The data management database(s) may be local (e.g., stored locally) or stored via the cloud or otherwise remote from the data management system 1475. In various embodiments, the encrypted data packets may be viewable in the database as encrypted (e.g., the encrypted values may be displayed within the database).

One or more of the encryption keys used to encrypt the data packets may be stored as a record on one of the distributed ledger subnet(s) 1495. In various embodiments, the data management system 1475 and/or the distributed ledger subnet(s) 1495 may generate a record for each data packet (or multiple records for each data packet in an instance in which the data packet includes information relating to multiple users). In various embodiments, the record generated may include a transaction identifier and a unique user identifier. The unique user identifier is associated with the user and used to encrypt (and decrypt) the data packets associated with the user. As such, each data packet is encrypted using the UUID associated with the user as the encryption key.

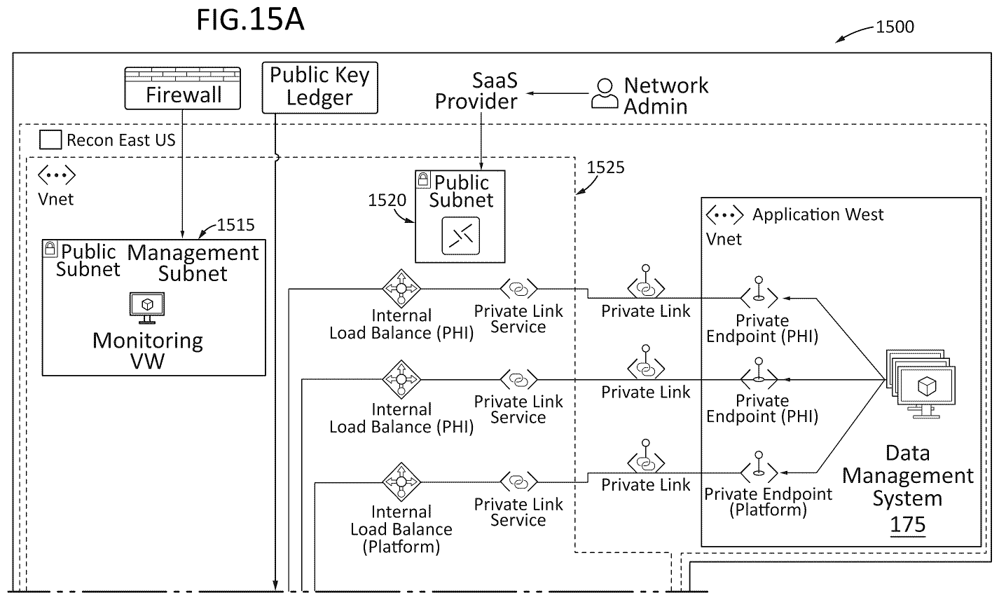

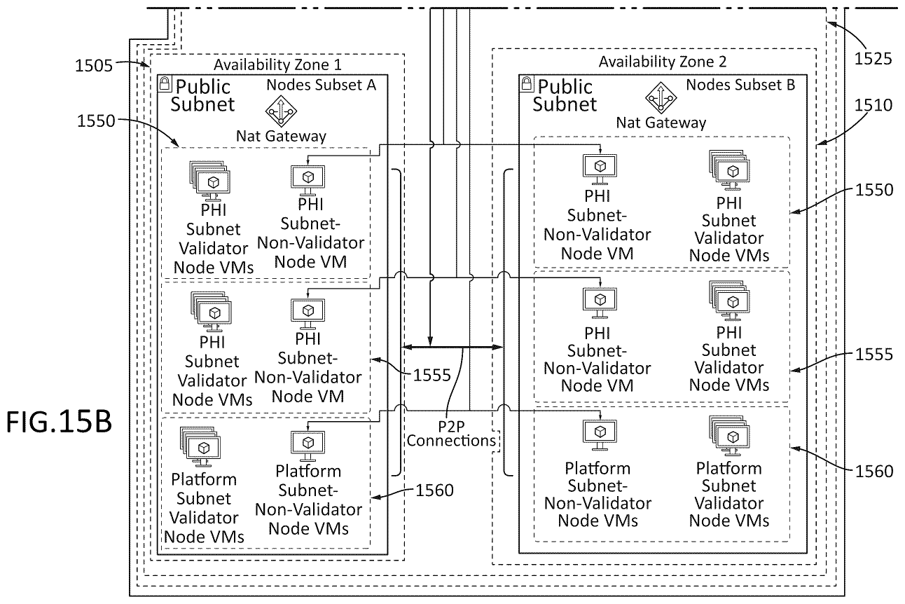

The data management system 1475 is in communication with the distributed ledger subnet(s) 1495. The data management system 1475 may send information to and receive information from the distributed ledger subnet(s) 1495. As such, the data management system 1475 may determine the distributed ledger subnet(s) 1495 to send and/or receive specific information. Operations relating to sending and/or receiving information relating to the distributed ledger subnets are discussed herein, such as in reference to FIGS. 15A and 15B.

The data management system 1475 may also receive and/or transfer information to computing device(s) 1452. The computing device(s) 1452 may be associated with a client of the entity associated with the data management system 1475. For example, the computing device(s) 1452 may be associated with an organization completing a clinical trial and receives data from the data management system 1475 associated with users in the given clinical trial. As such, the term “client” is in reference to clients of an entity associated with the data management system 1475. The computing device(s) 1452 may request data associated with one or more users (e.g., associated with one or more users in a clinical trial). The request may be approved by the given user (e.g., the user may have given approval upon signing up for clinical trial). The system may then perform the operations herein to decrypt the data packets requested by the computing device(s) 1452 and provide the non-encrypted values to the computing device(s) 152.

Referring now to FIGS. 15A and 15B, an example structure 1500 of distributed ledger subnets is shown. In the example shown in FIGS. 15A and 15B, the distributed ledger subnets include a nodes subnet A 1505, a nodes subnet B 1510, a management subnet 1515, and a SAAS public subnet 1520. The number of subnets and structure are merely an example and any number of subnets may be provided. Additionally, as shown, the distributed ledger subnets are shown as part of a singular distributed ledger 1525. However, the distributed ledger subnets may be distributed across multiple distributed ledgers. Each of the distributed ledger subnets may be public subnets.

Each of the nodes subnet A 1505 and the nodes subnet B 1510 are further segmented into subnets based on the data type of the data being stored. As shown, the nodes subnet A 1505 includes a PII subnet 1550, a PHI subnet 1555, and a Platform subnet 1560. As such, the segmented subnet (PII subnet, PHI subnet, platform subnet, etc.) are the distributed ledger subnets in which the operations herein discuss. For example, any of the PII subnet, the PHI subnet, or the platform subnet may be the first distributed ledger subnet. Various other subnets may be contemplated based on the various data types of data processed by the system. Additionally, the individual subnets (e.g., PII subnet, PHI subnet, platform subnet, etc.) that are distributed across multiple distributed ledger subnets (e.g., nodes subnet A 1505 and the nodes subnet B 1510) may be considered a singular subnet. For example, the PII subnet 1550 shown in nodes subnet A 1505 may be considered the same as the PII subnet 1550 shown in the nodes subnet B 1510. Alternatively, the subnets may be further segmented (e.g., based on region, patient information, etc.).

As shown in FIGS. 15A and 15B, the data management system 1575 may be in communication with the various distributed ledger subnets, such that the data management system 1575 may transmit and/or receive information from the various distributed ledger subnets. For example, the data management system 1575 may be in communication with the distributed ledger subnets to carry out operations.

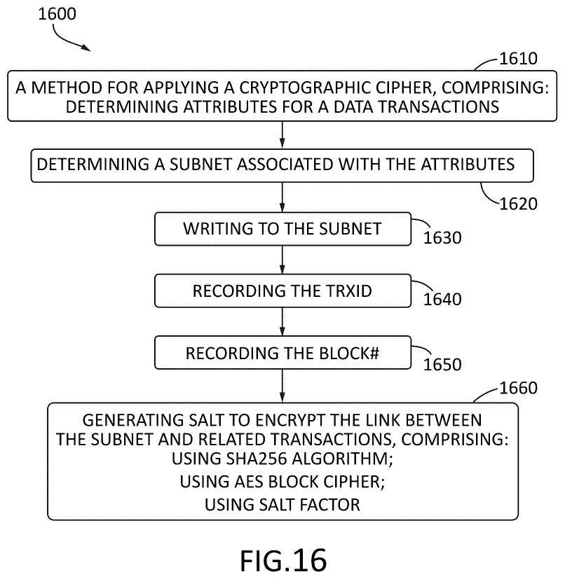

Referring now to FIG. 16, an illustration of a flowchart for a method of applying a cryptographic cipher according to the present disclosure is shown. In particular, in one aspect, at 1610, the method 1600 comprises determining attributes for a data transaction.

In another aspect, at 1620, the method 1600 comprises determining a subnet associated with the attributes.

In another aspect, at 1630, the method 1600 comprises writing to the subnet.

In another aspect, at 1640, the method 1600 comprises recording the trxID.

In another aspect, at 1650, the method 1600 comprises recording the block #.

In another aspect, at 1660, the method 1600 comprises generating salt to encrypt the link between the subnet and related transactions. In one aspect, generating the salt 1660 comprises using SHA256 algorithm. In another aspect, generating the salt 1660 comprises using AES block cipher. In another aspect, generating the salt 1660 comprise using salt value.

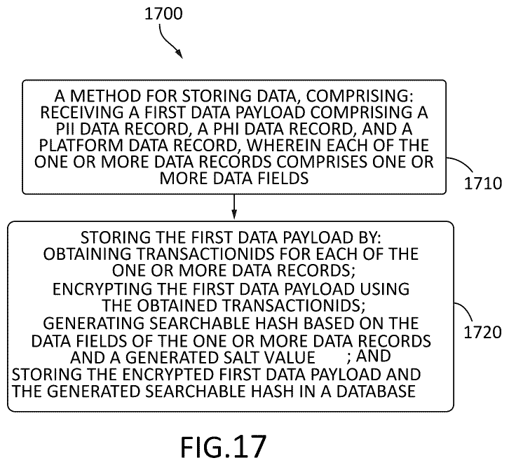

Referring now to FIG. 17, an illustration of a flowchart for a method of storing data according to the present disclosure is shown. In particular, in one aspect, at 1710, the method 1700 comprises receiving a first data payload comprising a PII data record, a PHI data record, and a platform data record, wherein each of the one or more data records comprises one or more data fields.

In another aspect, at 1720, the method 1700 comprises storing the first data payload. In one aspect, storing the first data payload comprises obtaining the transactionIDs for each of the one or more data records. In another aspect, storing the first data payload comprises encrypting the first data payload using the obtained transactionIDs. In another aspect, storing the first data payload comprises generating searchable hash based on the data fields of the one or more data records and a generated salt value. In another aspect, storing the first data payload comprises storing the encrypted first data payload and the generated searchable hash in a database.

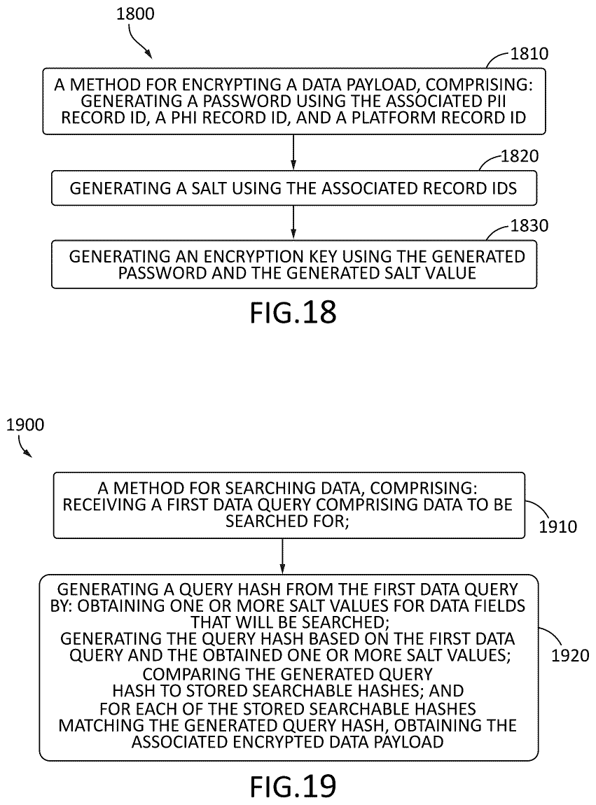

Referring now to FIG. 18, an illustration of a flowchart for a method of encrypting a data payload according to the present disclosure is shown. In particular, in one aspect, at 1810, the method 1800 comprises generating a password using the associated PII record id, a PHI record id, and a platform record id.

In another aspect, at 1820, the method 1800 comprises generating a salt using the associated record ids.

In another aspect, at 1830, the method 1800 comprises generating an encryption key using the generated password and the generated salt.

Referring now to FIG. 19, an illustration of a flowchart for a method of searching data according to the present disclosure is shown. In particular, in one aspect, at 1910, the method 1900 comprises receiving a first data query comprising data to be searched for.

In another aspect, at 1920, the method 1900 comprises generating a query hash from the first data query. In one aspect, generating the query hash comprises obtaining one or more salt values for data fields that will be searched. In another aspect, generating the query hash comprises encrypting the first data payload using the obtained transactionIDs. In another aspect, generating the query hash comprises generating the query hash based on the first data query and the obtained one or more salt values. In another aspect, generating the query hash comprises comparing the generated query hash to stored searchable hashes. In another aspect, generating the query hash comprises, for each of the stored searchable hashes matching the generated query hash, obtaining the associated encrypted data payload.

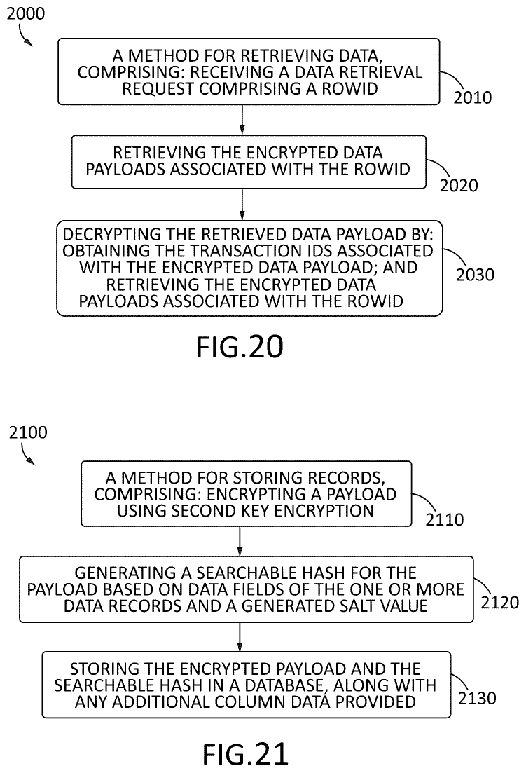

Referring to FIG. 20, an illustration of a flowchart for a method of retrieving data according to the present disclosure is shown. In particular, in one aspect, at 2010, the method 2000 comprises receiving a data retrieval request comprising a rowID.

In another aspect, at 2020, the method 2000 comprises retrieving the encrypted data payloads associated with the rowID.

In another aspect, at 2030, the method 2000 comprises decrypting the retrieved data payload. In one aspect, decrypting the retrieved data payload comprises obtaining the transactionIDs associated with the encrypted data payload. In another aspect, decrypting the retrieved data payload comprises retrieving the encrypted data payloads associated with the rowID.

Referring now to FIG. 21, an illustration of a flowchart for a method of storing records according to the present disclosure is shown. In particular, in one aspect, at 2110, the method 2100 comprises encrypting a payload using second key encryption.

In another aspect, at 2120, the method 2100 comprises generating a searchable hash for the payload based on data fields of the one or more data records and a generated salt value.

In another aspect, at 2130, the method 2100 comprises storing the encrypted payload and the searchable hash in a database, along with any additional column data provided.

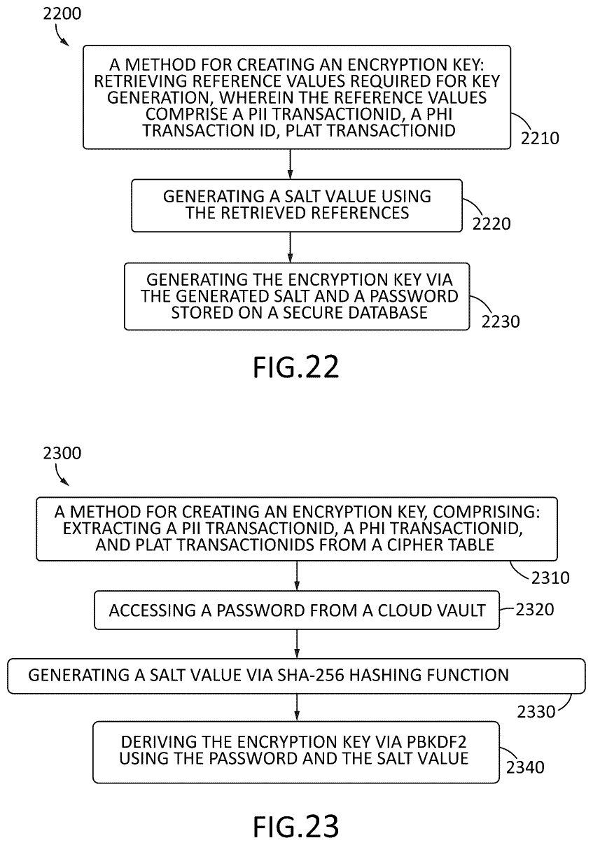

Referring now to FIG. 22, an illustration of a flowchart for a method of creating an encryption key according to the present disclosure is shown. In particular, in one aspect, at 2210, the method 2200 comprises retrieving reference values required for key generation, wherein the reference values comprise a PII transactionID, a PHI transactionID, plat transactionID.

In another aspect, at 2220, the method 2200 comprises generating a cryptographic salt using the retrieved references.

In another aspect, at 2230, the method 2200 comprises generating the encryption key via the generated salt and a password stored on a secure database.

Referring now to FIG. 23, an illustration of a flowchart for a method of creating an encryption key according to the present disclosure is shown. In particular, in one aspect, at 2310, the method 2300 comprises extracting a PII transactionID, a PHI transactionID, and plat transactionIDs from a cipher table.

In another aspect, at 2320, the method 2300 comprises accessing a password from a cloud vault.

In another aspect, at 2330, the method 2300 comprises generating a cryptographic salt via sha-256 hashing function.

In another aspect, at 2340, the method 2300 comprises deriving the encryption key via pbkdf2 using the password and the cryptographic salt.

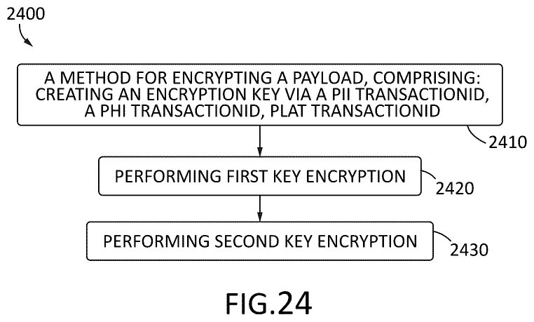

Referring now to FIG. 24, an illustration of a flowchart for a method of encrypting a payload according to the present disclosure is shown. In particular, in one aspect, at 2410, the method 2400 comprises creating an encryption key via a PII transactionID, a PHI transactionID, plat transactionID.

In another aspect, at 2420, the method 2400 comprises performing first key encryption.

In another aspect, at 2430, the method 2400 comprises performing second key encryption.

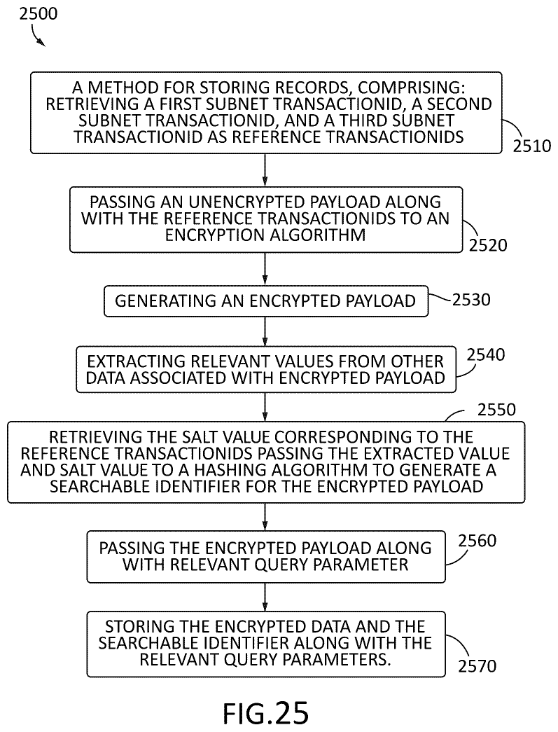

Referring now to FIG. 25 is an illustration of a flowchart for a method of storing records according to the present disclosure is shown. In particular, in one aspect, at 2510, the method 1600 comprises retrieving a first subnet transactionID, a second subnet transactionID, and a third subnet transactionID as reference transactionIDs.

In another aspect, at 2520, the method 2500 comprises passing an unencrypted payload along with the reference transactionIDs to an encryption algorithm.

In another aspect, at 2530, the method 2500 comprises generating an encrypted payload.

In another aspect, at 2540, the method 2500 comprises extracting relevant values from other data associated with encrypted payload.

In another aspect, at 2550, the method 2500 comprises retrieving the salt values corresponding to the reference transactionIDs passing the extracted value and salt values to a hashing algorithm to generate a searchable identifier for the encrypted payload.

In another aspect, at 2560, the method 2500 comprises passing the encrypted payload along with relevant query parameter.

In another aspect, at 2570, the method 2500 comprises storing the encrypted data and the searchable identifier along with the relevant query parameters.

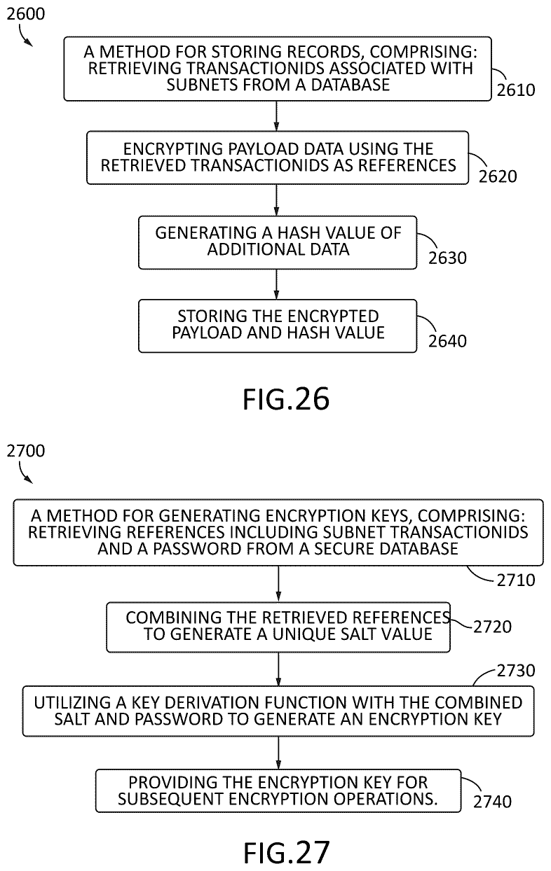

Referring now to FIG. 26, an illustration of a flowchart for a method of storing records according to the present disclosure is shown. In particular, in one aspect, at 2610, the method 2600 comprises retrieving transactionIDs associated with subnets from a database.

In another aspect, at 2620, the method 2600 comprises encrypting payload data using the retrieved transactionIDs as references.

In another aspect, at 2630, the method 2600 comprises generating a hash value of additional data.

In another aspect, at 2640, the method 2600 comprises storing the encrypted payload and hash value.

Referring now to FIG. 27, an illustration of a flowchart for a method of generating encryption keys according to the present disclosure is shown. In particular, in one aspect, at 2710, the method 2700 comprises retrieving references including subnet transactionIDs and a password from a secure database.

In another aspect, at 2720, the method 2700 comprises combining the retrieved references to generate a unique salt.

In another aspect, at 2730, the method 2700 comprises utilizing a key derivation function with the combined salt and password to generate an encryption key.

In another aspect, at 2740, the method 2700 comprises providing the encryption key for subsequent encryption operations.

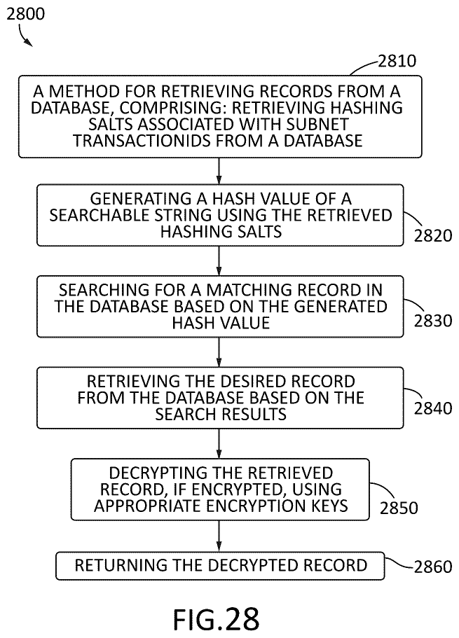

FIG. 28 is an illustration of a flowchart for a method of retrieving records from a database according to the present disclosure. In particular, in one aspect, at 2810, the method 2800 comprises retrieving hashing salts associated with subnet transactionIDs from a database. In another aspect, at 2820, the method 2800 comprises generating a hash value of a searchable string using the retrieved hashing salts.

In another aspect, at 2830, the method 2800 comprises searching for a matching record in the database based on the generated hash value.

In another aspect, at 2840, the method 2800 comprises retrieving the desired record from the database based on the search results.

In another aspect, at 2850, the method 2800 comprises decrypting the retrieved record, if encrypted, using appropriate encryption keys.

In another aspect, at 2860, the method 2800 comprises returning the decrypted record.

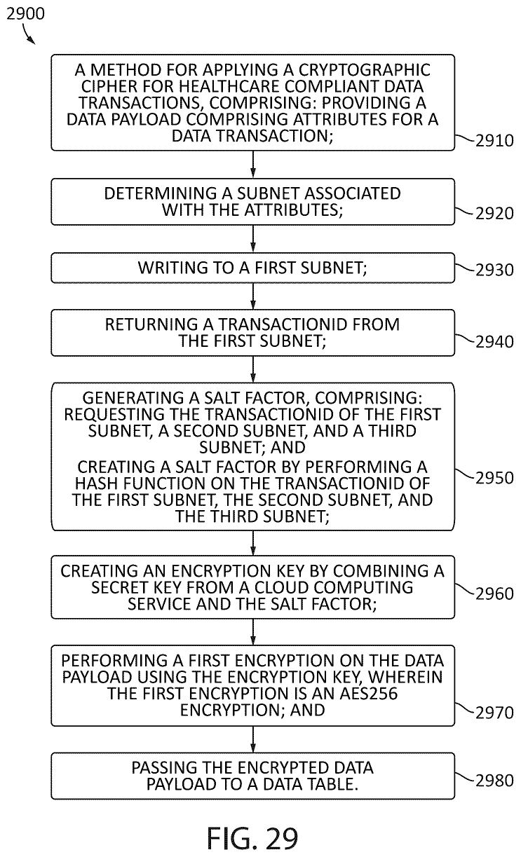

Referring now to FIG. 29, an illustration of a flowchart for a method of applying a cryptographic cipher for healthcare compliant data transactions according to the present disclosure is shown. In particular, in one aspect, at 2910, the method 2900 comprises providing a data payload comprising attributes for a data transaction.

In another aspect, at 2920, the method 2900 comprises determining a subnet associated with the attributes.

In another aspect, at 2930, the method 2900 comprises writing to a first subnet.

In another aspect, at 2940, the method 2900 comprises returning a transactionID from the first subnet.

In another aspect, at 2950, the method 2900 comprises generating a salt value. In one aspect, generating the salt value comprises requesting the transactionID of the first subnet, a second subnet, and a third subnet. In another aspect, generating the salt value comprises creating a salt value by performing a hash function on the transactionID of the first subnet, the second subnet, and the third subnet.

In another aspect, at 2960, the method 2900 comprises creating an encryption key by combining a secret key from a cloud computing service and the salt value.

In another aspect, at 2970, the method 2900 comprises performing a first encryption on the data payload using the encryption key, wherein the first encryption is an aes256 encryption.

In another aspect, at 2980, the method 2900 comprises passing the encrypted data payload to a data table.

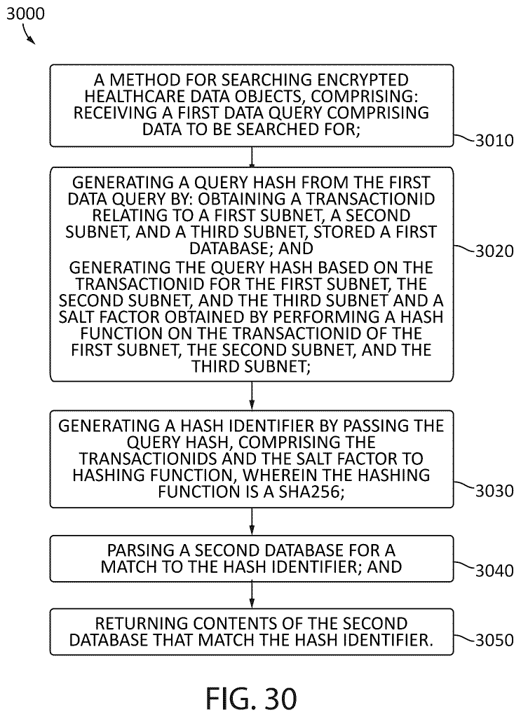

Referring to FIG. 30, an illustration of a flowchart for a method of searching encrypted healthcare data objects according to the present disclosure is shown. In particular, in one aspect, at 3010, the method 3000 comprises receiving a first data query comprising data to be searched for.

In another aspect, at 3020, the method 3000 comprises generating a query hash from the first data query. In one aspect, generating the query hash from the first data query comprises obtaining a transactionID relating to a first subnet, a second subnet, and a third subnet, stored a first database. In another aspect, generating the query hash from the first data query comprises generating the query hash based on the transactionID for the first subnet, the second subnet, and the third subnet and a salt value obtained by performing a hash function on the transactionID of the first subnet, the second subnet, and the third subnet.

In another aspect, at 3030, the method 3000 comprises generating a hash identifier by passing the query hash, comprising the transactionIDs and the salt value to hashing function, wherein the hashing function is a sha256.

In another aspect, at 3040, the method 3000 comprises parsing a second database for a match to the hash identifier.

In another aspect, at 3050, the method 3000 comprises returning contents of the second database that match the hash identifier.

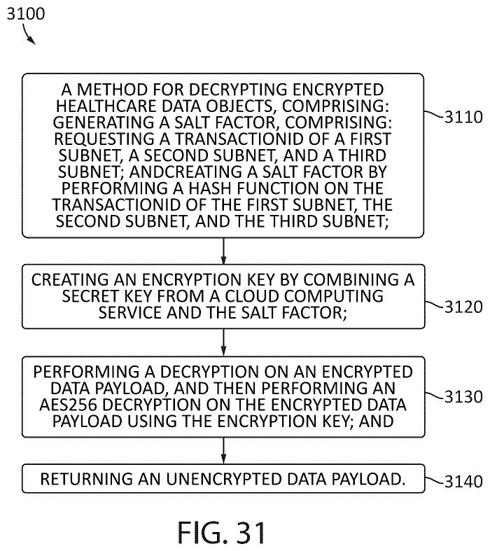

Referring now to FIG. 31, an illustration of a flowchart for a method of decrypting encrypted healthcare data objects according to the present disclosure is shown. In particular, in one aspect, at 3110, the method 3100 comprises generating a salt value. In another aspect generating the salt value comprises requesting a transactionID of a first subnet, a second subnet, and a third subnet. In another aspect, generating the salt value comprises creating a salt value by performing a hash function on the transactionID of the first subnet, the second subnet, and the third subnet.

In another aspect, at 3120, the method 3100 comprises creating an encryption key by combining a secret key from a cloud computing service and the salt value.

In another aspect, at 3130, the method 3100 comprises performing a decryption on an encrypted data payload, and then performing an AES256 decryption on the encrypted data payload using the encryption key.

In another aspect, at 3140, the method 3100 comprises returning an unencrypted data payload.

While the operations herein are discussed in reference to first, second, third (e.g., a first data packet, a first user, a first distributed ledger subnet, etc.), the terms are not necessarily chronological (e.g., a first data packet need not be received before a second data packet) or sequential (e.g., a first user need not be before a second user) unless otherwise noted. Additionally, the operations carried out on a first data packet may be carried out on additional data packets (e.g., a second data packet, a third data packet, etc.). Various data packets may be associated with different users (e.g., a first user, a second user, a third user, etc.). Unless otherwise noted, the operations discussed herein may be carried out for any number of different data packets, users, distributed subnets, and/or the like.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The devices, modules, and other functional units described in this disclosure can be implemented by hardware, or software, or a combination of hardware and software. In some embodiments, functions described as being implemented in hardware may instead be implemented in software or a combination of hardware and software. Likewise, in some embodiments, functions described as being implemented in software may instead be implemented in hardware or a combination of hardware and software. If something is implemented by software, it may be stored in a non-transitory computer-readable media, like the computer-readable media described above. Such software, when executed by a processor, may perform the function of the device, module or other functional unit the software is implementing. The above-described devices, modules, and other functions units may also be combined or may be further divided into a plurality of sub-units.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### IV. Claim Clauses

Certain implementations of systems and methods consistent with the present disclosure are provided as follows.

Clause 1. A method for applying a cryptographic cipher for healthcare compliant data transactions, comprising: providing a data payload comprising attributes for a data transaction; determining a subnet associated with the attributes; writing to a first subnet; returning a transactionID from the first subnet; generating a salt value, comprising: requesting the transactionID of the first subnet, a second subnet, and a third subnet; and creating a salt value by performing a hash function on the transactionID of the first subnet, the second subnet, and the third subnet; creating an encryption key by combining a secret key from a cloud computing service and the salt value; performing a first encryption on the data payload using the encryption key, wherein the first encryption is an AES256 encryption; and passing the encrypted data payload to a data table.

Clause 2. The method of clause 1, wherein the attributes comprise first name, last name, date of birth, phone number, or email address.

Clause 3. The method of clause 1, wherein the data transaction comprises a JSON payload including one or more attributes.

Clause 4. The method of clause 1, wherein the subnet further comprises a PII subnet, a PHI subnet, and a PLAT subnet.

Clause 5. The method of clause 1, wherein the subnet is a dynamic validator working to achieve consensus.

Clause 6. The method of clause 1, wherein the subnet has a consensus engine.

Clause 7. The method of clause 1, wherein writing to the subnet comprises: selecting metadata; writing the metadata to blockchain of the subnet; and returning the transactionID.

Clause 8. The method of clause 1, further comprising performing a second encryption to further encrypt the data payload.

Clause 9. A method for searching encrypted healthcare data objects, comprising: receiving a first data query comprising data to be searched for; generating a query hash from the first data query by: obtaining a transactionID relating to a first subnet, a second subnet, and a third subnet, stored a first database; and generating the query hash based on the transactionID for the first subnet, the second subnet, and the third subnet and a salt value obtained by performing a hash function on the transactionID of the first subnet, the second subnet, and the third subnet; generating a hash identifier by passing the query hash, comprising the transactionIDs and the salt value to hashing function, wherein the hashing function is a SHA256; parsing a second database for a match to the hash identifier; and returning contents of the second database that match the hash identifier.

Clause 10. The method of clause 9, wherein the data to be searched for comprises first name, last name, date of birth, phone number, or email address.

Clause 11. The method of clause 9, wherein each of the subnets is either a PII subnet, a PHI subnet, or a PLAT subnet.

Clause 12. The method of clause 9, wherein each of the subnets is a dynamic validator working to achieve consensus.

Clause 13. The method of clause 9, wherein each of the subnets has a consensus engine.

Clause 14. A method for decrypting encrypted healthcare data objects, comprising: generating a salt value, comprising: requesting a transactionID of a first subnet, a second subnet, and a third subnet; and creating a salt value by performing a hashing function on the transactionID of the first subnet, the second subnet, and the third subnet; creating an encryption key by combining a secret key from a cloud computing service and the salt value; performing a decryption on an encrypted data payload, and then performing an AES256 decryption on the encrypted data payload using the encryption key; and returning an unencrypted data payload.

Clause 15. The method of clause 14, wherein the unencrypted data payload comprises first name, last name, date of birth, phone number, or email address.

Clause 16. The method of clause 14, wherein each of the subnets is either a PII subnet, a PHI subnet, or a PLAT subnet.

Clause 17. The method of clause 14, wherein each of the subnets is a dynamic validator working to achieve consensus.

Clause 18. The method of clause 14, wherein each of the subnets has a consensus engine.

Clause 19. The method of clause 14, wherein the hashing function is a SHA256.

Clause 20. The method of clause 14, wherein the encryption key is created using a PBKDF2.

Clause 21. A cryptographic cipher for the segmentation of personally identifiable information, protected health information, and platform permissioning, comprising: an AES block cipher with SHA-256, involving: a SALT encryption standard and a serialized blockchain protocol, whereby the synergistic combination provides three layer security along with the serialized blockchain protocol as a 4th layer leveraging a blockchain cryptographic trxID(s), and whereby the resulting synergistic combination allows the cipher to generate an ID unique to a data element, for the secure segmentation of PII, PHI, and PLATFORM permissioning.

Clause 22. A method for applying a cryptographic cipher, comprising: determining attributes for a data transaction; determining a subnet associated with the attributes; writing to the subnet; recording the trxID; recording the block #; generating SALT to encrypt the link between the subnet and related transactions, comprising: using SHA256 algorithm; using AES block cipher; using Salt value.

Clause 23. The method of clause 22, wherein the trxID and the block # are used as variables to decipher data by the cryptographic cipher.

Clause 24. The method of clause 22, wherein the AES block cipher is used for reconstituting data.

Clause 25. A method for storing data, comprising: receiving a first data payload comprising a PII data record, a PHI data record, and a platform data record, wherein each of the one or more data records comprises one or more data fields; and storing the first data payload by: obtaining the transactionIDs for each of the one or more data records; encrypting the first data payload using the obtained transactionIDs; generate searchable hash based on the data fields of the one or more data records and a generated salt value; and storing the encrypted first data payload and the generated searchable hash in a database.

Clause 26. A system for storing data, comprising: a networking interface configured to receive a first data payload comprising a PII data record, a PHI data record, and a platform data record, wherein each of the one or more data records comprises one or more data fields; memory configured to store data; and a processor configured to store the first data payload in the memory by: obtaining the transactionIDs for each of the one or more data records; encrypting the first data payload using the obtained transactionIDs; generate searchable hash based on the data fields of the one or more data records and a generated salt value; and storing the encrypted first data payload and the generated searchable hash in the memory as part of a database.

Clause 27. A method for encrypting a data payload, comprising: generating a password using the associated PII record ID, a PHI record ID, and a platform record ID; generating a salt using the associated record IDs; and generating an encryption key using the generated password and the generated salt.

Clause 28. A system for encrypting a data payload, comprising: memory configured to store data; and a processor configured to: generate a password using the associated PII record ID, a PHI record ID, and a platform record ID; generate a salt using the associated record IDs; and generate an encryption key using the generated password and the generated salt.

Clause 29. A method for searching data, comprising: receiving a first data query comprising data to be searched for; generating a query hash from the first data query by: obtaining one or more salt values for data fields that will be searched; and generating the query hash based on the first data query and the obtained one or more salt values; comparing the generated query hash to stored searchable hashes; and for each of the stored searchable hashes matching the generated query hash, obtaining the associated encrypted data payload.

Clause 30. A system for searching data, comprising: a networking interface configured to receive a first data query comprising data to be searched for; memory configured to store data; and a processor configured to: generate a query hash from the first data query by: obtaining one or more salt values for data fields that will be searched; and generating the query hash based on the first data query and the obtained one or more salt values; compare the generated query hash to stored searchable hashes; and for each of the stored searchable hashes matching the generated query hash, obtain the associated encrypted data payload from the memory.

Clause 31. A method for retrieving data, comprising: receiving a data retrieval request comprising a row ID; retrieving the encrypted data payloads associated with the row ID; and decrypting the retrieved data payload by: obtaining the transactionIDs associated with the encrypted data payload; and decrypting the encrypted data payload using the obtained transactionIDs.

Clause 32. A system for retrieving data, comprising: an input/output (IO) interface configured to receive a data retrieval request comprising a row ID; memory configured to store data; and a processor configured to: retrieve the encrypted data payloads associated with the row ID from the memory; and decrypt the retrieved data payload by: obtaining the transactionIDs associated with the encrypted data payload; and decrypting the encrypted data payload using the obtained transactionIDs.

Clause 33. A cryptographic cipher for the segmentation of personally identifiable information, protected health information, and platform permissioning, comprising: an RSA Signature protocol with SHA-256, involving: a SALT encryption standard and a serialized blockchain protocol, whereby the synergistic combination provides three layer security along with the serialized blockchain protocol as a 4th layer leveraging a blockchain cryptographic trxID(s), and whereby the resulting synergistic combination allows the cipher to generate an ID unique to a data element, for the secure segmentation of PII, PHI, and PLATFORM permissioning.

Clause 34. A method for applying a cryptographic cipher, comprising: determining attributes for a data transaction; determining a subnet associated with the attributes; writing to the subnet; recording the trxID; recording the block #; generating SALT to encrypt the link between the subnet and related transactions, comprising: using SHA256 algorithm; using RSA algorithm; and using Salt value.

Clause 35. The method of clause 34, wherein the trxID and the block # are used as variables to decipher data by the cryptographic cipher.

Clause 36. The method of claim 34, wherein the RSA algorithm is used for reconstituting data.

What is claimed is:

1. A method for applying a cryptographic cipher for healthcare compliant data transactions, comprising:
providing a data payload comprising attributes for a data transaction;
determining a subnet associated with the attributes;
writing to a first subnet;
returning a transactionID from the first subnet;
generating a salt value, comprising:
requesting the transactionID of the first subnet, a second subnet, and a third subnet; and
performing a hash function on the transactionID of the first subnet, the second subnet, and the third subnet;
creating an encryption key by combining a secret key from a cloud computing service and the salt value;
performing a first encryption on the data payload using the encryption key, wherein the first encryption is an AES256 encryption; and
passing the encrypted data payload to a data table.

2. The method of claim 1, wherein the attributes comprise first name, last name, date of birth, phone number, or email address.

3. The method of claim 1, wherein the data transaction comprises a JSON payload including one or more attributes.

4. The method of claim 1, wherein the subnet further comprises a PII subnet, a PHI subnet, and a PLAT subnet.

5. The method of claim 1, wherein the subnet is a dynamic validator working to achieve consensus.

6. The method of claim 1, wherein the subnet has a consensus engine.

7. The method of claim 1, wherein writing to the subnet comprises:
selecting metadata;
writing the metadata to blockchain of the subnet; and
returning the transactionID.

8. The method of claim 1, further comprising performing a second encryption to further encrypt the data payload.

9. A method for searching encrypted healthcare data objects, comprising:
receiving a first data query comprising data to be searched for;
generating a query hash from the first data query by:
obtaining a transactionID relating to a first subnet, a second subnet, and a third subnet, stored a first database; and
generating the query hash based on the transactionID for the first subnet, the second subnet, and the third subnet and a salt value obtained by performing a hash function on the transactionID of the first subnet, the second subnet, and the third subnet;
generating a hash identifier by passing the query hash, comprising the transactionIDs and the salt value to hashing function, wherein the hashing function is a SHA256;
parsing a second database for a match to the hash identifier; and
returning contents of the second database that match the hash identifier.

10. The method of claim 9, wherein the data to be searched for comprises first name, last name, date of birth, phone number, or email address.

11. The method of claim 9, wherein each of the subnets is either a PII subnet, a PHI subnet, or a PLAT subnet.

12. The method of claim 9, wherein each of the subnets is a dynamic validator working to achieve consensus.

13. The method of claim 9, wherein each of the subnets has a consensus engine.

14. A method for decrypting encrypted healthcare data objects, comprising:
generating a salt value, comprising:
requesting a transactionID of a first subnet, a second subnet, and a third subnet; and
performing a hashing function on the transactionID of the first subnet, the second subnet, and the third subnet;
creating an encryption key by combining a secret key from a cloud computing service and the salt value;
performing a decryption on an encrypted data payload, and then performing an AES256 decryption on the encrypted data payload using the encryption key; and
returning an unencrypted data payload.

15. The method of claim 14, wherein the unencrypted data payload comprises first name, last name, date of birth, phone number, or email address.

16. The method of claim 14, wherein each of the subnets is either a PII subnet, a PHI subnet, or a PLAT subnet.

17. The method of claim 14, wherein each of the subnets is a dynamic validator working to achieve consensus.

18. The method of claim 14, wherein each of the subnets has a consensus engine.

19. The method of claim 14, wherein the hashing function is a SHA256.

20. The method of claim 14, wherein the encryption key is created using a PBKDF2.
